(19) United States
(12) Patent Application Publication
(10) Pub. No.: US 2019/0164307 A1
(43) Pub. Date: May 30, 2019

(54) RECOGNITION SYSTEM, STORAGE SYSTEM INCLUDING RECOGNITION SYSTEM, SHOPPING ASSISTANCE SYSTEM INCLUDING STORAGE SYSTEM, STORAGE CONTROL METHOD, AND NON-TRANSITORY STORAGE MEDIUM

(71) Applicant: Panasonic Intellectual Property Management Co., Ltd., Osaka (JP)

(72) Inventors: Kazutoshi AIDA, Osaka (JP); Akihito SAKANAKA, Osaka (JP); Masataka EJIMA, Chiba (JP); Masayuki KIMURA, Tokyo (JP)

(21) Appl. No.: 16/200,921

(22) Filed: Nov. 27, 2018

(30) Foreign Application Priority Data
Nov. 28, 2017 (JP) 2017-228448

(51) Int. Cl. G06T 7/70; G06Q 20/20

(52) U.S. Cl. CPC G06T 7/70; G06Q 20/208

(57) ABSTRACT

A recognition system includes a recognition processing unit and a determining processor. The recognition processing unit is configured to recognize a state in a container which allows one or more goods to be put in. The determining processor is configured to determine, based on a recognition result by the recognition processing unit in a transfer operation, whether or not the transfer operation is normal. The transfer operation is an operation of transferring each of the one or more goods from the container into a bag (different container) by a movement mechanism (a support, a guide section, and an elevator unit) configured to move each of the one or more goods.

### CROSS-REFERENCE TO RELATED APPLICATION

The present application is based upon and claims the benefit of priority of Japanese Patent Application No. 2017-228448, filed on Nov. 28, 2017, the entire contents of which are incorporated herein by reference.

### TECHNICAL FIELD

The present disclosure generally relates to recognition systems, storage systems including the recognition systems, shopping assistance systems including the storage systems, storage control methods, and non-transitory storage media. Specifically, the present disclosure relates to a recognition system for assisting customers in purchasing goods, a storage system including the recognition system, a shopping assistance system including the storage system, a storage control method, and a non-transitory storage medium.

### BACKGROUND ART

Document 1 (JP H05-89364 A) discloses a system (POS system) attempting to realize retail stores without clerks. The system disclosed in Document 1 includes a basket and a transaction terminal apparatus. The basket allows goods to be put in. The basket includes a scanner configured to read goods information (goods data) and a transmission circuit configured to transmit the goods information to the outside. The transaction terminal apparatus includes a reception circuit configured to receive the goods information, a scale configured to measure a weight of the goods put in the basket, and a controller configured to compare weight data corresponding to the respective pieces of goods information with a measured value measured by the scale. When the measured value by the scale matches a total weight represented by the weight data, the transaction terminal apparatus performs a checkout process.

In the configuration described in Document 1, however, when goods are in the basket (container), an employee (clerk) of the store or a customer has to transfer the goods into another container such as a shopping bag after the checkout process. As a result, a time from the start of the checkout process until the customer receives the goods is increased, which may lead to an increased time for shopping.

To solve the above-described problems, a machine may be caused to perform a job of transferring the goods from the container into another container, but in this case, remaining of goods in the container or the like may cause a problem in the job.

### SUMMARY

In view of the foregoing, it is an object of the present disclosure to provide a recognition system in which a problem is suppressed in a job of transferring goods from a container into a different container by a machine, a storage system including the recognition system, a shopping assistance system including the storage system, a storage control method, and a non-transitory storage medium.

A recognition system according to one aspect of the present disclosure includes a recognition processing unit and a determining processor. The recognition processing unit is configured to recognize a state in a container which allows one or more goods to be put in. The determining processor determines, based on a recognition result by the recognition processing unit in a transfer operation, whether or not the transfer operation is normal. The transfer operation is an operation of transferring each of the one or more goods from the container into a different container by a movement mechanism configured to move each of the one or more goods.

A storage system according to one aspect of the present disclosure includes: the recognition system; and a storage device. The storage device is configured to perform the transfer operation.

A shopping assistance system according to one aspect of the present disclosure includes: the above storage system; and a sales system configured to perform a sales process of the one or more goods put in the container.

A storage control method according to one aspect of the present disclosure includes recognizing a state in a container which allows one or more goods to be put in. The storage control method further includes determining, based on a recognition result in a transfer operation, whether or not the transfer operation is normal. The transfer operation is an operation of transferring each of the one or more goods from the container into a different container by a movement mechanism configured to move each of the one or more goods. The storage control method further includes controlling the movement mechanism based on a determination result.

A non-transitory storage medium according to one aspect of the present disclosure is a non-transitory storage medium recording a program for causing a computer system to execute a recognition process, a determining process, and a storage control process. The recognition process is a process of recognizing a state in a container which allows one or more goods to be put in. The determining process is a process of determining, based on a recognition result in a transfer operation, whether or not the transfer operation is normal. The transfer operation is an operation of transferring each of the one or more goods from the container into a different container by a movement mechanism configured to move each of the one or more goods. The storage control process is a process of controlling the movement mechanism based on a determination result by the determining process.

### BRIEF DESCRIPTION OF DRAWINGS

FIG. 1 is a conceptual view illustrating a schematic configuration of a storage system including a recognition system according to one embodiment of the present disclosure;

FIG. 2 is a block diagram illustrating a schematic configuration of a shopping assistance system including the storage system;

FIG. 3 is an exterior perspective view of a counter desk to which the shopping assistance system is applied;

FIG. 4 is a conceptual view illustrating a positional relationship between a ranging sensor included in the recognition system and a container;

FIGS. 5A to 5C are views each illustrating an operation of a storage device included in the storage system;

FIGS. 6A to 6C are views each illustrating the operation of the storage device;

FIG. 7 is a flowchart illustrating a first determining process of the recognition system;

FIG. 8A is a conceptual view illustrating an example of a first image in a case where an item of goods is not stuck at an outlet in the first determining process, FIG. 8B is a conceptual view illustrating an example of a second image in a case where the item of goods is not stuck at the outlet in the first determining process, FIG. 8C is a conceptual view illustrating an example of a first image in a case where an item of goods is stuck at an outlet in the first determining process, and FIG. 8D is a conceptual view illustrating an example of a second image in a case where the item of goods is stuck at the outlet in the first determining process;

FIG. 9 is a sectional view illustrating a state of the storage device in a case where the item of goods is stuck at the outlet in the first determining process;

FIG. 10 is a conceptual view illustrating an example of correction in the first determining process;

FIG. 11 is a flowchart illustrating a second determining process of the recognition system;

FIG. 12A is a conceptual view illustrating an example of a third image in a case where no goods remain in the container in the second determining process, and FIG. 12B is a conceptual view illustrating an example of the third image in a case where the goods remain in the container in the second determining process;

FIG. 13 is a sectional view illustrating a state of a storage device in a case where the goods remain in the container in the second determining process; and

FIG. 14 is a conceptual view illustrating an example of correction in the second determining process.

### DETAILED DESCRIPTION

(1) Schema

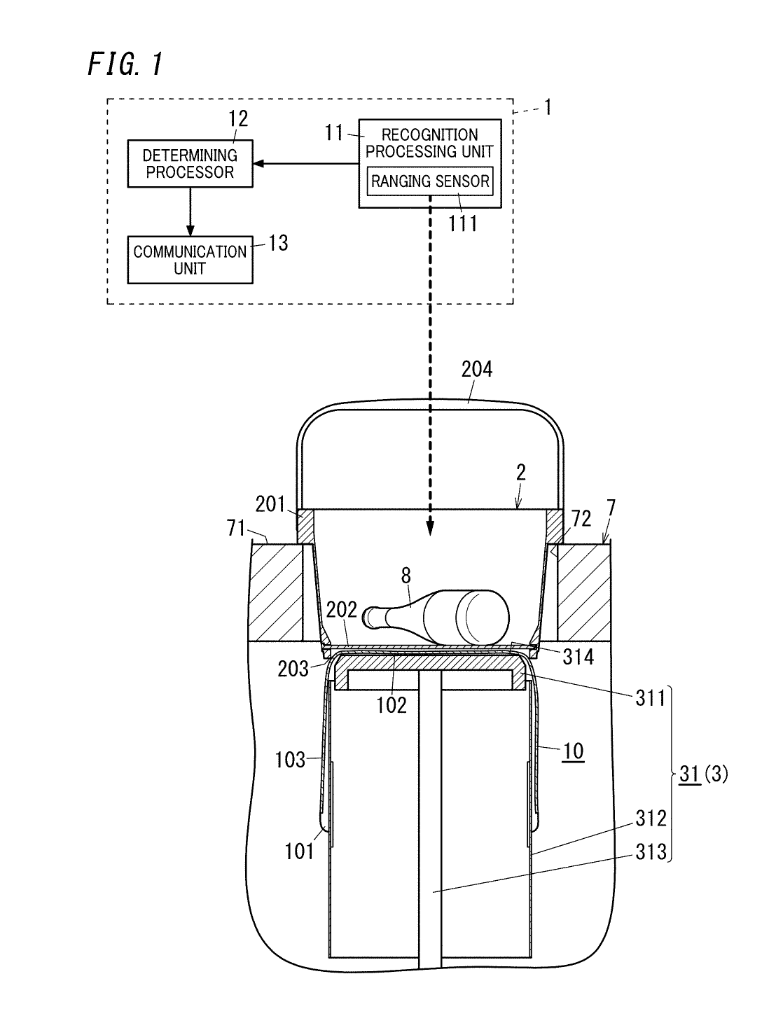

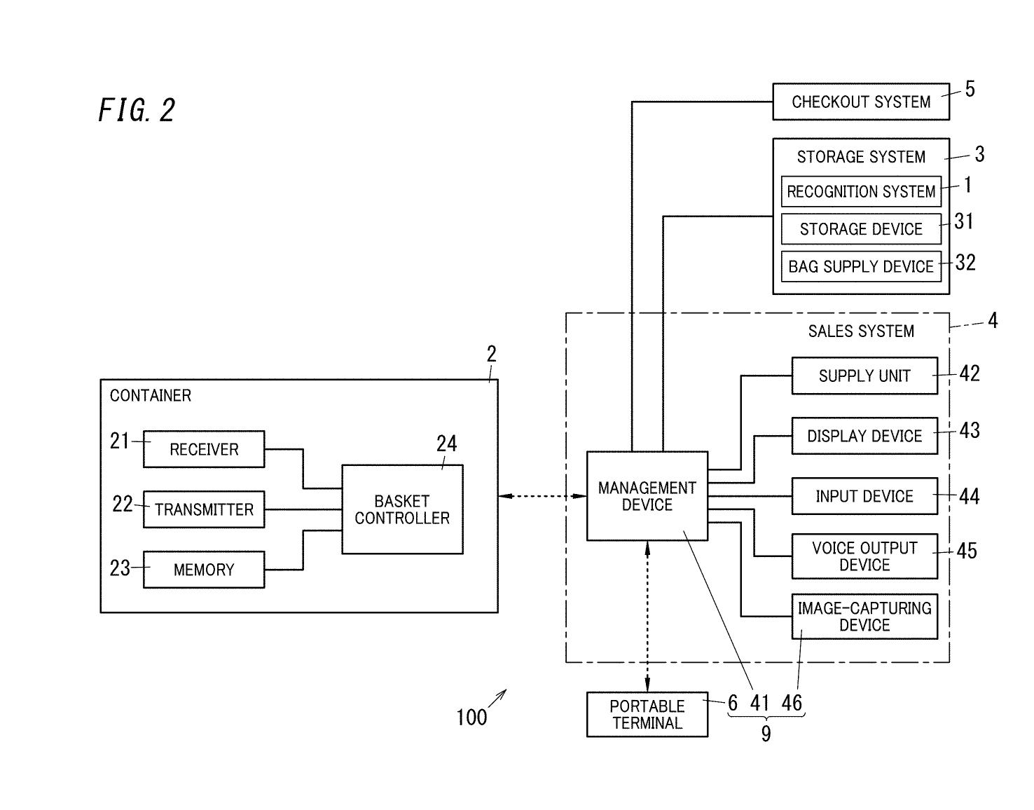

As illustrated in FIGS. 1 and 2, a recognition system 1 according to the present embodiment, together with a storage device 31 configured to perform a transfer operation, forms a storage system 3 configured to perform the transfer operation of goods 8 (or products). In the present disclosure, “transfer operation” refers to an operation of transferring each of the goods 8 from a container 2 into a different container 10 by a movement mechanism (a support 311, a guide section 312, and an elevator unit 313 which will be described later) configured to move each of the goods 8. In the present embodiment, the container 2 is a shopping basket. Moreover, in the present embodiment, the different container 10 is made of polyethylene as what is called bag body, a so-called shopping bag (or a plastic shopping bag). The different container 10 is hereinafter also referred to as a “bag 10”. It is only required that the bag has a dimension that allows the goods 8 to be put in, and the bag has a bag opening through which each of the goods 8 is put in or taken out.

As illustrated in FIG. 2, the storage system 3, together with a sales system 4, forms a shopping assistance system 100 for assisting customers in shopping. In other words, the shopping assistance system 100 includes the storage system 3 and the sales system 4. The shopping assistance system 100 is introduced in retail stores such as convenience stores, supermarkets, department stores, drugstores, electronics retail stores, or hardware stores.

The sales system 4 is a system configured to directly or indirectly communicate with the container 2 and to perform a sales process (or a checkout process) of goods 8 put in the container 2. As used herein, a “sales process” refers to various processes required for actions (sales and purchase) of transferring the ownership of goods from a seller (store) to a buyer (customer) and paying the seller the consideration (charge) for the goods by the buyer. The sales process includes, for example, an acquisition process, an order process, and the like. The acquisition process is a process of acquiring respective one or more goods information on one or more goods 8 picked up by a customer in a store. The order process is a process of receiving, from a customer, an order for one or more goods 8 which the customer wishes to buy.

Stores which the shopping assistance system 100 is introduced into enable customers to finish purchasing goods 8 by a series of actions of choosing the goods 8 in the stores, putting them in the container 2, performing the checkout process thereof, and receiving the bag 10 in which the goods 8 have automatically been stored. Thus, with the shopping assistance system 100, it is possible to reduce, for example, a time from the start of the checkout process to the customer getting the goods 8 while saving clerk's labor and customers' labor, thereby reducing customers' shopping time.

As illustrated in FIG. 1, the recognition system 1 includes a recognition processing unit 11 and a determining processor 12. In the present embodiment, the recognition system 1 is applied to the container 2 placed at a predetermined location (in the present embodiment, on a bottom of a recess 72 in a counter desk 7 which will be described later). Note that the recognition system 1 is not applied to, for example, a container 2 stocked in a basket area near an entrance of the store. That is, the predetermined location does not include the basket area.

The recognition processing unit 11 is configured to recognize a state in the container 2 which allows one or more goods 8 to be put in. In the present disclosure, “state in the container” includes a state where the one or more goods 8 are put in the container 2 placed at the predetermined location as well as a state where no goods 8 are put in the container 2 placed at the predetermined location.

The determining processor 12 determines, based on a recognition result by the recognition processing unit 11 in the transfer operation, whether or not the transfer operation is normal. That is, in the transfer operation, the one or more goods 8 are transferred from the container 2 to the different container 10, and thus, the state in the container 2 changes along with the transfer operation. The state in the container 2 is different between a case where the one or more goods 8 are successfully transferred from the container 2 into the different container 10 smoothly and a case where, for example, one or more goods 8 remain in the container 2 and an abnormality occurs in the process of transferring each of the one or more goods 8 from the container 2 into the different container 10. This enables the determining processor 12 to determine whether or not the transfer operation is normal based on the recognition result by the recognition processing unit 11 in the transfer operation, that is, the state in the container 2 in the transfer operation.

As described above, in the present embodiment, it is possible to determine whether or not each of the one or more goods 8 is normally transferred from the container 2 into the different container 10 smoothly and whether or not an abnormality occurs in the process of transferring each of the one or more goods 8 from the container 2 into the different container 10. Thus, in the present embodiment, based on the determination result, if the abnormality is included in, for example, the transfer operation, a customer, a clerk, or the like is allowed to perform correction so that the transfer operation is normally performed. Thus, the present embodiment provides the advantage that a problem is suppressed in a job of transferring each of the one or more goods 8 from the container 2 into the different container 10 by a machine (here, the movement mechanism) than in a case where normality/abnormality of the transfer operation is not determined.

(2) Details

The recognition system 1 according to the present embodiment, the storage system 3 including the recognition system 1, and the shopping assistance system 100 including the recognition system 1 will be described in detail below. In the present embodiment, a convenience store is exemplified as a store which the shopping assistance system 100 is introduced into. That is, a “user” in the present disclosure is a customer in the convenience store and/or an employee (clerk) in the convenience store.

(2.1) Shopping Assistance System

Herein, the overall structure of the shopping assistance system 100 according to the present embodiment will first be explained. As shown in FIG. 2, the shopping assistance system 100 includes: the container 2; the storage system 3 including the recognition system 1; the sales system 4; and a checkout system 5. Note that the container 2 and the checkout system 5 do not have to be components included in the shopping assistance system 100. The container 2 will be described in detail in “(2.2) Container” which will be described later. The recognition system 1 and the storage system 3 will be described in detail in “(2.3) Storage System” which will be described later.

The sales system 4 includes a management device 41, a supply unit 42, display device 43, an input device 44, a voice output device 45, and an image-capturing device 46. Each of the supply unit 42, the display device 43, the input device 44, the voice output device 45, and the image-capturing device 46 is a peripheral device of the management device 41 and is connected to the management device 41.

The management device 41 is configured to receive goods information (which will be described later) transmitted from the container 2. The management device 41 is connected to the checkout system 5 configured to perform a checkout process. The management device 41 is configured to communicate with a store terminal composed of, for example, a point of sale (POS) terminal. The management device 41 is configured to perform a predetermined process such as a transmission process of transmitting information required for the checkout process performed by the checkout system 5 to the checkout system 5 based on the goods information received from the container 2. The management device 41 is configured to communicate also with the storage system 3 and a portable terminal 6 to control the storage system 3 and the portable terminal 6.

The checkout system 5 includes a computer system as a main component and peripheral devices such as a cash unit configured to accept and dispense cash. The checkout system 5 is configured to cause a processor of the computer system to execute a program stored in a memory of the computer system, thereby performing the checkout process such as calculation of a checkout amount based on the goods information received from the sales system 4. The checkout system 5 includes a card reader and a printer configured to issue a receipt. The card reader is configured to read, for example, credit card information and electronic money card information for payment, mobile phone terminal information, member's card information, and loyalty card information. Information such as for example, detailed statement, checkout amount, purchase date and time is described in the receipt.

In the present embodiment, the checkout system 5 stores price data corresponding to each piece of goods information. In addition, the checkout system 5, the store server, or the center server may store: an information set such as advertisement information, discount information, producer information and recipe information, corresponding to each piece of goods information; and information such as gender, age, favorite and past purchase history, corresponding to each customer information. The information set, which is not stored in the sales system 4, is available to the sales system 4 as a result of the sales system 4 communicating with the checkout system 5, the store server, or the center server.

The supply unit 42 is configured to supply customers with one or more specific goods (e.g., cigarettes). The display device 43 is a device configured to display various kinds of information to customers. The input device 44 is a device configured to receive an operation performed by a customer through, for example, gesture detection. Moreover, the input device 44 includes a microphone and has a function of applying speech recognition and semantic analysis to a voice signal output from the microphone. Thus, a voice operation (voice input) by a customer is also possible. The voice output device 45 includes a loudspeaker and is configured to provide customers with various kinds of information by the voice.

That is, the sales system 4 uses the display device 43, the input device 44, and the voice output device 45 as user interfaces to provide customers with various kinds of information by the display or the voice and to receive operations (including voice input) by the customers. Note that provision of the information by the sales system 4 may be realized by at least one of the display and the voice. That is, the provision of the information may be realized by any one of the display and the voice, or realized by a combination of the display and the voice.

As an example, the sales system 4 may provide customers with messages such as “Welcome” and “Thank you very much” when the arrival of the customers is sensed and when the checkout process is completed. It is accordingly possible to give customers a sense of affinity like clerk service. For example, customers are to operate the input device 44 to select one of payment methods to pay the checkout amount displayed on the display device 43. The sales system 4 may also provide customers with a utilization procedure for the shopping assistance system 100 by the display device 43 and the voice output device 45. In this case, for example, when the container 2 is placed at a predetermined location (on the bottom of the recess 72 in the counter desk 7), the display device 43 and the voice output device 45 then explain each step of the utilization procedure sequentially, thereby confirming whether or not the fast food or the cigarettes are purchased, etc.

The image-capturing device 46 is a camera configured to photograph customers. The image-capturing device 46, together with the management device 41 and the portable terminal 6, forms an age verification system 9. In other words, the age verification system 9 includes the management device 41, the image-capturing device 46, and the portable terminal 6. The age verification system 9 is a system configured to assist a clerk (checker) in checking the age of a customer (subject).

The portable terminal 6 is a terminal carried by a clerk. The portable terminal 6 is configured to wirelessly perform two-way communication with the management device 41 by a radio wave as a medium. The management device 41 transmits a request signal to the portable terminal 6. The request signal includes image data of an image obtained by capturing an image of a subject (customer) as a target of the age verification. The portable terminal 6 receives the request signal, and based on the image data included in the request signal, the portable terminal 6 displays on-screen age verification including the image obtained by capturing an image of the subject. In this state, a checker (clerk) watches the on-screen age verification displayed on the portable terminal 6 to perform age verification of the subject. When receiving a result of the age verification performed by the checker as an operation by the checker, the portable terminal 6 transmits a response signal including the result of the age verification to the management device 41.

(2.2) Container

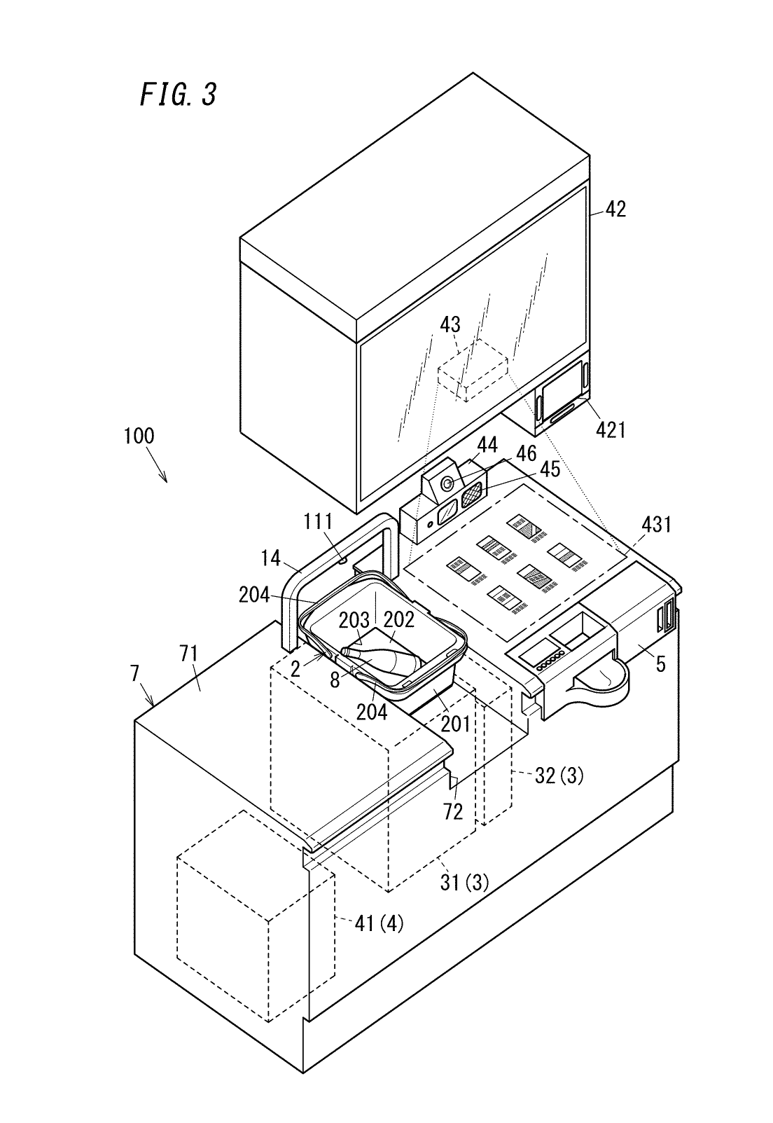

Next, the container 2 will be described in detail. The container 2 is a shopping basket, includes a basket body 201 and a bottom panel 202, and allows one or more goods 8 to be put in as illustrated in FIGS. 1 and 3. The basket body 201 is provided with a pair of grips 204 which are to be gripped by a customer. The basket body 201 has an opening at its bottom. The bottom panel 202 is slidable between a closed position closing the bottom (lower opening) of the basket body 201 and an open position. That is, the bottom panel 202 is attached to the basket body 201 so as to allow the bottom of the basket body 201 to be closed and opened. This enables the one or more goods 8 put in the container 2 to be discharged through the bottom of the basket body 201.

That is, in the present embodiment, the bottom of the basket body 201 is an opening (outlet) 203 through which the one or more goods 8 are taken out of the container 2 in the transfer operation. The container 2 is configured to open and close the outlet 203 when the bottom panel 202 is opened and closed.

As illustrated in FIG. 2, the container 2 includes a receiver 21, a transmitter 22, a memory 23, and a basket controller 24.

The receiver 21 is configured to read respective goods information on one or more goods 8 put in the basket body 201 to acquire the respective goods information on the one or more goods 8. In the present disclosure “goods information” is information for identifying each of goods 8 (information identification code), and examples thereof in Japan include Japanese Article Number (JAN) code and the like. Examples of the goods identification code include European Article Number (EAN) code in Europe, Universal Product Code (UPC) in USA and the like in addition to the JAN code. The receiver 21 is exposed from the outer side surface of, for example, the basket body 201. The receiver 21 is a barcode reader and optically reads a barcode that each of the goods 8 carries to acquire goods information thereon. Therefore, a customer picks up each of the goods 8 to show it to the receiver 21 and then puts it in the basket body 201. In this case, it can be said that the goods information on each of the goods 8 put in the basket body 201 has been acquired by the receiver 21. The receiver 21 is not limited to the barcode reader, but examples thereof may further include a reader configured to read a two-dimensional code and a tag reader configured to read goods information from a radio-frequency identification (RFID) tag in a contactless manner.

The receiver 21 may also be configured to read goods information from, for example, each image of the goods 8. In this example, the receiver 21 includes an image sensor configured to photograph the goods 8 inside or outside the basket body 201. The receiver 21 may specify respective goods information of the goods 8 by performing image recognition processing with respect to each of the goods 8, extracting feature such as outline, color and texture information therefrom, and verifying by comparing the feature with a template stored for each of goods 8 in advance. In this example, the receiver 21 may utilize information read with the barcode reader as auxiliary information for reading goods information from each image of the goods 8. Alternatively, the barcode reader may be omitted when it is possible to sufficiently read goods information from only each image of goods 8.

The transmitter 22 is configured to transmit goods information acquired through the receiver 21 to the sales system 4. In the present embodiment, the transmitter 22 is composed of a communication module configured to perform two-way communication with the sales system 4. The transmitter 22 communicates with the sales system 4 by optical wireless communication whose medium is radiation such as infrared radiation or visible radiation. Among different types of wireless communication, especially, near field type communication (near field wireless communication) having a narrow communication area is applicable because the transmitter 22 transmits goods information with the basket body 201 placed on the counter desk 7.

The memory 23 is configured to store one or more pieces of goods information. For example, whenever the receiver 21 reads goods information, the goods information is stored in the memory 23. The transmitter 22 may transmit the one or more pieces of goods information stored in the memory 23 all together to the sales system 4 or divide the one or more pieces of goods information into packets to transmit the packets to the sales system 4. In the present embodiment, the memory 23 stores goods information acquired through the receiver 21 and the number thereof (i.e., acquisition count of goods information by the receiver 21). For example, when there is one or more pieces of goods information as respective goods information on three goods 8 that include two goods 8 of “A” and one item of goods 8 (or one product) of “B”, the memory 23 stores goods information on “A”, “2” as count thereof, goods information “B”, and “1” as count thereof. For example, when the transmitter 22 succeeds in transmitting the one or more pieces of goods information to the sales system 4, the one or more pieces of goods information stored in the memory 23 is deleted.

The basket controller 24 includes a microcontroller as a main component and is configured to cause a processor of the microcontroller to execute a program stored in a memory of the microcontroller, thereby controlling each part such as the receiver 21. The program may be stored in the memory in advance, provided via a telecommunications network such as the Internet, or provided by a storage medium such as a memory card storing the program.

(2.3) Storage System

Next, the storage system 3 will be described in detail. As illustrated in FIG. 2, the storage system 3 includes a storage device 31, a bag supply device 32, and the recognition system 1.

The storage device 31 performs, on an item of goods 8 in the container 2, the transfer operation of transferring the item of goods 8 from the container 2 to the bag 10, which enables the item of goods 8 to be stored in the bag (different container) 10. That is, a customer picks up an item of goods 8 in a store, puts it in the container 2, and places the container 2, in which the item of goods 8 having been put, on the predetermined location (on the bottom of the recess 72 in the counter desk 7), which causes the storage device 31 to perform transferring of the item of goods 8. Thus, a customer does not have to take the item of goods 8 out of the container 2 for transferring them, and thus, the customer can easily transfer the item of goods 8 by the storage device 31. When goods 8 are put in the container 2, the storage device 31 is capable of collectively transferring the goods 8.

In the present embodiment, the management device 41 is configured to control the storage system 3 in an interlocked manner with the sales system 4 such that each of one or more goods 8 are transferred while the customer performs a checkout process or the like by the checkout system 5. For example, the storage system 3 starts transferring one or more goods 8 when the checkout process is started in the checkout system 5.

The bag supply device 32 is a device configured to supply bags 10 to the storage device 31. The bag supply device 32 takes a bag 10 one by one from a bag stocker in which a plurality of bags 10 are stocked, and the bag supply device 32 supplies the bag 10 which is taken out to the storage device 31. In the present embodiment, the management device 41 controls the bag supply device 32 in an interlocked manner with the storage device 31 such that always one bag 10 is set (disposed) to the storage device 31. That is, the storage device 31 is configured to use one bag 10 supplied from the bag supply device 32 to perform transferring. Each time the storage device 31 performs transferring for one time, a new bag 10 provided for the next transferring is supplied from the bag supply device 32 to the storage device 31. In other words, the bag supply device 32 starts supplying a bag 10 to the storage device 31 when the storage device 31 completes transferring.

Next, the storage device 31 will be described in further detail. As illustrated in FIG. 1, the storage device 31 includes the support 311, the guide section 312, and the elevator unit 313 (driver). The support 311, the guide section 312, and the elevator unit 313 constitute a movement mechanism configured to move goods 8.

The support 311 has a rectangular plate shape. An upper surface of the support 311 is a mount surface 314 on which goods 8 are to be mounted. In the present embodiment, the mount surface 314 has a rectangular shape with rounded corners.

The guide section 312 is in a shape of a cylinder. Of an upper surface and a lower surface of the cylinder, at least the upper surface is an opening. In the present embodiment, the guide section 312 is in a shape of a rectangular cylinder. Both an upper surface and a lower surface of the rectangular cylinder are openings. The openings of the guide section 312 are slightly larger than the mount surface 314. The guide section 312 is disposed around the support 311 along the outer periphery of the mount surface 314. Here, the shape of an inner peripheral edge of an upper end surface of the guide section 312 and the shape of an outer periphery of the mount surface 314 are in a similarity relationship.

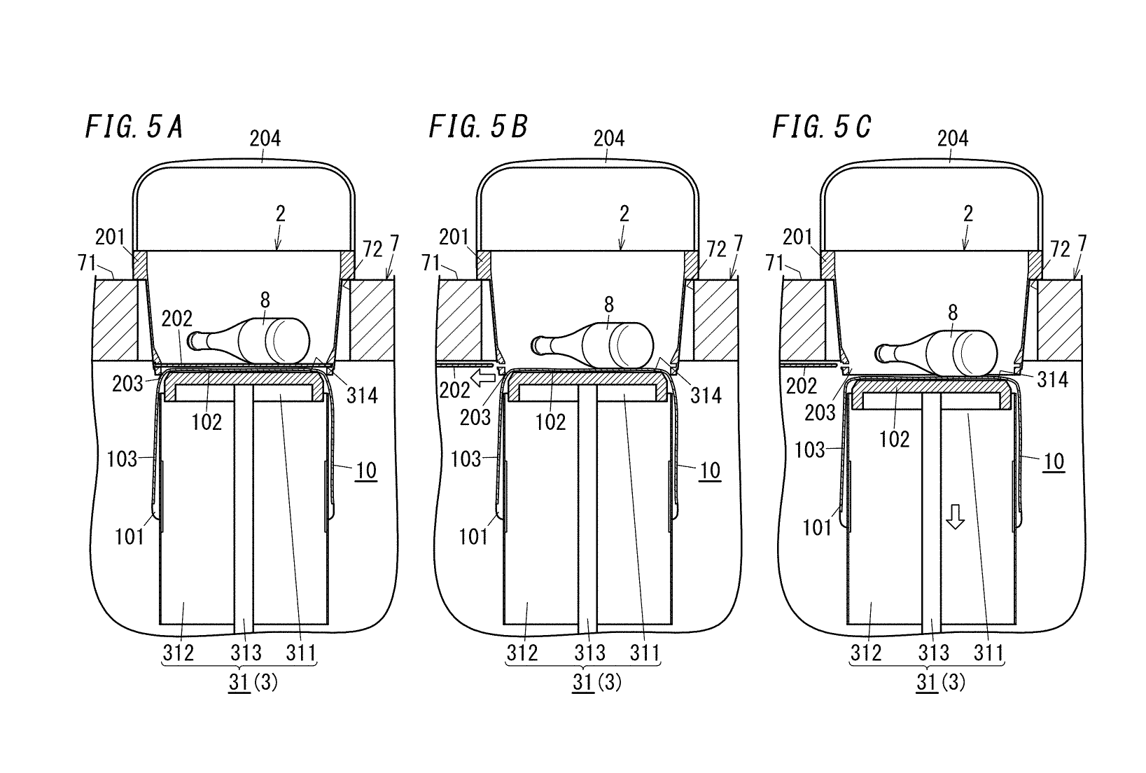

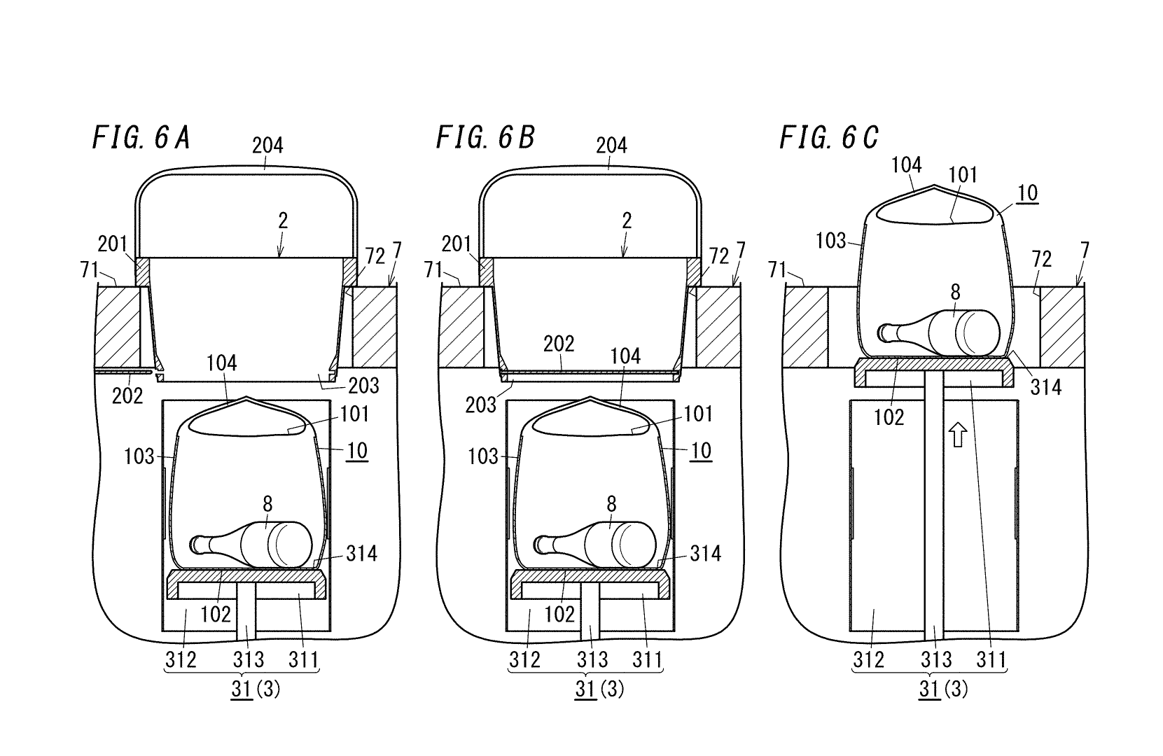

The elevator unit 313 is configured to change the relative positional relationship between the support 311 and the guide section 312 from a first state to a second state and then to a third state. In the present embodiment, a state where the support 311 is located at an upper end of the guide section 312 is defined as the first state (see FIGS. 5A and 5B). When the relative positional relationship between the support 311 and the guide section 312 corresponds to the first state, the upper surface (mount surface 314) of the support 311 is located at a slightly higher level than the upper end surface of the guide section 312. Thus, in the first state, the support 311 is disposed to close the opening at the upper surface of the guide section 312. The second state is defined as a state where the location of the support 311 relative to the guide section 312 is at a lower level than in the first state (see FIG. 5C). The third state is a state where the location of the support 311 relative to the guide section 312 is at a further lower level than in the second state (see FIG. 6A).

In the present embodiment, the travel distance of the support 311 from the first state to the second state is preferably several percent to several ten percent (e.g., 10% to 20%) of the travel distance of the support 311 from the first state to the third state. For example, when the travel distance of the support 311 from the first state to the third state is 30 cm, the travel distance of the support 311 from the first state to the second state is preferably 3 cm to 6 cm. This is because, although one or more goods 8 may stick at an outlet 203 of the container 2 in the first state as described later, and the one or more goods 8 may be released from the outlet 203 in the second state and collide with the support 311, the travel distance defined as described above leads to a relatively small influence of the collision on the one of more goods 8.

The elevator unit 313 includes an electric motor (motor). The elevator unit 313 is realized by an appropriate mechanism which enables direct advance of the support 311 in the vertical direction by driving force generated by the electric motor of, for example, a pantograph type or a rack and pinion type. The elevator unit 313 is configured to move only the support 311 of the support 311 and the guide section 312 downward, thereby changing the relative positional relationship between the support 311 and the guide section 312 from the first state to the second state and then to the third state. That is, the support 311 is configured to move in the guide section 312 which is tubular and which is fixed at a fixed position in the vertical direction by the elevator unit 313.

In the present embodiment, the storage device 31 includes a holding mechanism for holding a bottom part 102 of the bag 10 on the mount surface 314, in addition to the support 311, the guide section 312, and the elevator unit 313. The holding mechanism clamps the bottom part 102 of the bag 10 to hold the bottom part 102. The storage device 31 keeps the bottom part 102 of the bag 10 held on the mount surface 314 by the holding mechanism at least while the relative positional relationship between the support 311 and the guide section 312 changes from the first state to the third state.

As illustrated in FIGS. 5A to 5C and FIG. 6A, when the relative positional relationship between the support 311 and the guide section 312 changes from the first state to the third state, an item of goods 8 discharged through the outlet 203 of the container 2 moves in the bag 10. That is, in the present embodiment, the transfer operation of transferring the item of goods 8 from the container 2 into the bag (different container) 10 by the storage device 31 ends when the relative positional relationship between the support 311 and the guide section 312 has changed from the first state to the third state. In the present embodiment, the transfer operation is an operation of lowering the item of goods 8 with respect to the container 2 in a state where the outlet 203 of the container 2 is open, to change the positional relationship of the item of goods 8 relative to the container 2 to transfer the item of goods 8 from the container 2 through the outlet 203 into the bag (different container) 10. Operation of the storage device 31 including the transfer operation will be described in detail in “(3.1) Operation of Storage Device” which will be described later.

Next, the recognition system 1 will be described. As illustrated in FIG. 1, the recognition system 1 includes the recognition processing unit 11, the determining processor 12, and a communication unit 13. As described later, the recognition processing unit 11 (a ranging sensor 111) is disposed outside the counter desk 7, but the determining processor 12 and the communication unit 13 may be built in the counter desk 7 or may be disposed on an upper surface 71 of the counter desk 7. Note that the broken line arrow shown in FIG. 1 expresses an electromagnetic wave emitted from the ranging sensor 111 and traveling toward an object in the container 2 in a simulated manner.

The recognition processing unit 11 is configured to recognize the state in the container 2. In the present embodiment, the recognition processing unit 11 includes the ranging sensor 111. The ranging sensor 111 is, for example, a ranging image sensor adopting infrared radiation and is configured to measure the distance from the ranging sensor 111 to the object by a time-of-flight (TOF) method. In the present disclosure, “object” refers to an object in the container 2 and includes the support 311 of the storage device 31 in addition to the item of goods 8 put in the container 2. The support 311 faces the interior of the container 2 through the outlet 203 in a state where the bottom panel 202 is open.

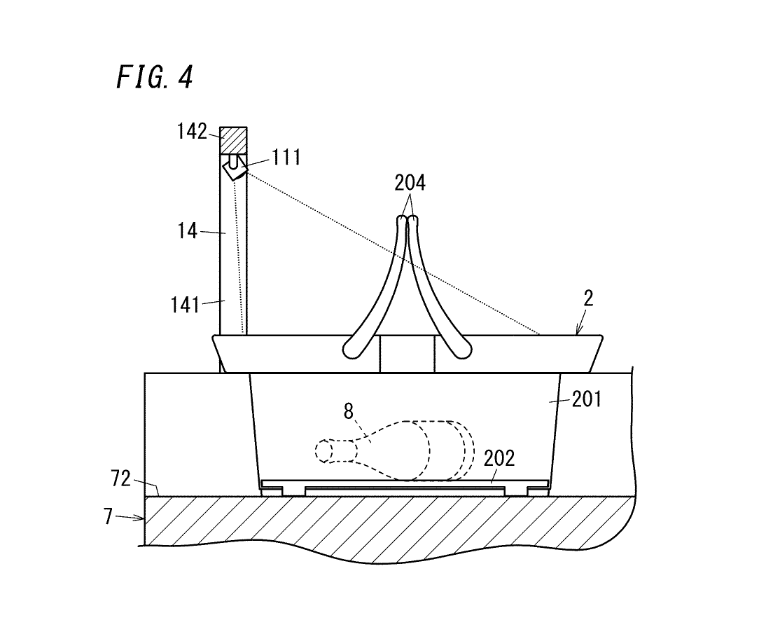

In the present embodiment, the ranging sensor 111 is, as illustrated in FIGS. 3 and 4, attached to an arch 14 installed on the upper surface 71 of the counter desk 7. That is, the recognition processing unit 11 (ranging sensor 111) is installed outside the counter desk 7 (more specifically, outside the container 2). The arch 14 includes a pair of supports 141 and a beam 142. The pair of supports 141 is installed on the upper surface 71 of the counter desk 7 to straddle the recess 72 and rises upward from the upper surface 71. The beam 142 connects respective upper ends of the pair of supports 141. The ranging sensor 111 is attached to a center portion in the lengthwise direction of the beam 142.

The arch 14 is disposed at a location on a rear side from the central portion of the counter desk 7 as viewed from the front side of the counter desk 7. Thus, the ranging sensor 111 is disposed at a location which is deviated from the center of the container 2 in a horizontal surface viewed in the gravity direction (the vertical direction of the upper surface 71 of the counter desk 7). Thus, in the present embodiment, the ranging sensor 111 measures the distance to an object in the container 2 placed at a predetermined location (the bottom of the recess 72 in the counter desk 7) not from directly above the container 2 but from obliquely above the container 2.

The ranging sensor 111 measures the distance to the object in the container 2 to acquire a distance image. Each of a plurality of pixels included in the distance image includes distance information. In the present disclosure, “distance information” refers to information denoting the distance from the ranging sensor 111 to the object. The distance information is, for example, represented by luminance (color), but in the present embodiment, the distance information is represented by shade instead of the luminance (color). A lighter color represents a shorter distance from the ranging sensor 111 to the object. A darker color represents a longer the distance from the ranging sensor 111 to the object.

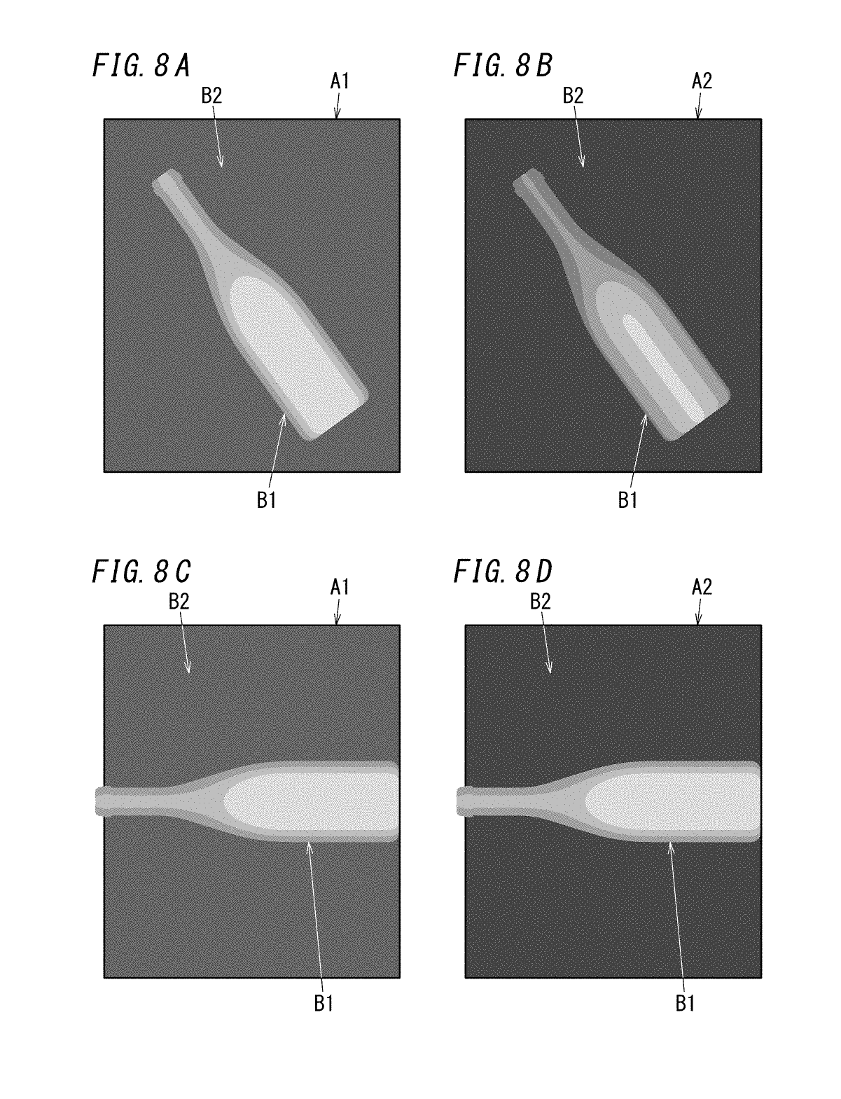

An example of the distance image is shown in FIG. 8A. The distance image shown in FIG. 8A represents a case where the item of goods 8 is a bottle containing beverage (hereinafter simply referred to as a “bottle”), and this distance image represents a state where the bottle lays on the mount surface 314. In this case, the body of the bottle is closer to the ranging sensor 111 than the neck of the bottle is. Thus, in the distance image, an area corresponding to the body of the bottle has a lighter color than an area corresponding to the neck of the bottle. Moreover, the mount surface 314 is located farther away from the ranging sensor 111 than the bottle is. Thus, in the distance image, an area B2 corresponding to the mount surface 314 has a darker color than an area B1 corresponding to the bottle.

Here, the ranging sensor 111 in the present embodiment is disposed obliquely above the container 2 as described above. Thus, the distance image is corrected by appropriate image processing such as trapezoid correction so as to be an image equivalent to a distance image obtained when the distance to the object in the container 2 is measured from directly above the container 2 placed at the predetermined location. In the following description, a distance image after the image processing is simply referred to as a “distance image”. The image processing may be performed by the recognition processing unit 11 or may be performed by the determining processor 12. Note that the relative positional relationship between the ranging sensor 111 and the container 2 placed at the predetermined location is substantially fixed. Thus, when parameters used for the image processing are preset before the recognition system 1 is used, the parameters do not have to be set each time measuring by the ranging sensor 111 is performed.

As described above, the ranging sensor 111 is disposed outside the container 2 and is configured to measure the distance to the object present in the container 2. The recognition processing unit 11 (ranging sensor 111) recognizes the state in the container 2 based on a measurement result by the ranging sensor 111, that is, based on the distance from the ranging sensor 111 to the object in the container 2.

The determining processor 12 includes one or more processors and a memory and executes a program stored in the memory by the one or more processors, thereby executing a determining process. The determining process is a process of determining whether or not the transfer operation is normal based on the recognition result by the recognition processing unit 11 in the transfer operation (in this embodiment, the distance from the ranging sensor 111 to the object in the container 2). That is, the determining process is executed when the storage device 31 transfers the goods 8 from the container 2 into the bag (different container) 10. The program may be stored in the memory in advance, provided via a telecommunications network such as the Internet, or provided by a storage medium such as a memory card storing the program.

In the present embodiment, the determining processor 12 executes, as the determining process, a first determining process and a second determining process. The first determining process is a process of determining whether or not one or more goods 8 are stuck at the outlet 203 of the container 2 so as to determine whether or not the transfer operation is normal. The second determining process is a process of determining, when the relative positional relationship between the support 311 and the guide section 312 corresponds to the third state, whether or not one or more goods 8 remain in the container 2 so as to determine whether or not the transfer operation is normal. The determining process by the determining processor 12 will be described in detail in “(3.3) Operation of Recognition System” which will be described later.

The communication unit 13 outputs a notification signal when the determining processor 12 determines that the transfer operation is abnormal. In the present disclosure, “abnormality of transfer operation” mainly refers to a situation where one or more goods 8 are stuck at the outlet 203 of the container 2 or a situation where one or more goods 8 remain in the container 2 when the relative positional relationship between the support 311 and the guide section 312 corresponds to the third state. In the present embodiment, the communication unit 13 outputs the notification signal to the sales system 4 (in this embodiment, the management device 41). In the present embodiment, the communication unit 13 includes a communication module configured to perform one-way communication with the sales system 4. The communication unit 13 performs, for example, communication with the sales system 4 through wireless communication whose medium is a radio wave such as Wi-Fi (registered trademark) or Bluetooth (registered trademark). The communication unit 13 transmits the notification signal to the sales system 4 through wireless communication.

As illustrated in FIG. 3, the shopping assistance system 100 is disposed, for example, in the periphery of a counter desk 7 installed at a checkout counter of a store. That is, in the periphery of the counter desk 7, the shopping assistance system 100 is provided. A plurality of counter desks 7 may be provided to one store.

The counter desk 7 is formed with a recess 72 that opens in a substantially central portion of the upper surface 71 in a lengthwise direction (lateral direction). The recess 72 serves as a space that allows the basket body 201 of the container 2 to be put in. The recess 72 opens backward as viewed from the front side of the counter desk 7. Thus, a customer slides the basket body 201 of the container 2 along the bottom of the recess 72 in the horizontal direction, which enables the basket body 201 to be placed in the recess 72.

The storage device 31 and the bag supply device 32 are installed under the recess 72. On the bottom of the recess 72, the mount surface 314 of the support 311 of the storage device 31 is exposed in a space (that is, predetermined location) in which the basket body 201 of the container 2 is to be placed. Thus, when the storage device 31 opens the bottom panel 202 of the container 2 placed at the predetermined location, an item of goods 8 in the container 2 are discharged onto the mount surface 314. Then, the storage device 31 transfers the item of goods 8 placed on the mount surface 314.

The supply unit 42 is suspended from a ceiling to be provided above the counter desk 7. The management device 41 is built in the counter desk 7. The checkout system 5 is disposed on the right side of the storage device 31 as viewed from the front side of the counter desk 7. The display device 43 is fixed to a lower surface of the supply unit 42 and is configured to project an image onto a screen 431 by, for example, a projection mapping technique. Herein, the display device 43 projects an image onto a right region with respect to the storage device 31 in the upper surface 71 of the counter desk 7 as viewed from the front side of the counter desk 7. That is, the right region with respect to the storage device 31 in the upper surface 71 of the counter desk 7 serves as the screen 431 of the display device 43. The input device 44 is on the upper surface 71 of the counter desk 7 and is disposed behind the screen 431 as viewed from the front side of the counter desk 7. The input device 44 is provided integrally with the voice output device 45.

The positional relationship, shapes, and the like of components of the shopping assistance system 100 described above are mere examples and may accordingly be modified. For example, the storage device 31 and the recess 72 may be disposed at one end (left end or right end) in the width direction (lateral direction) of the counter desk 7. Moreover, the recess 72 formed in the counter desk 7 is not an essential configuration for the shopping assistance system 100. For example, the upper surface 71 of the counter desk 7 may have a space (predetermined location) in which the basket body 201 of the container 2 is to be placed.

(3) Operation

Operation of the shopping assistance system 100 according to the present embodiment will be described below.

(3.1) Basic Operation

A basic operation of the shopping assistance system 100 from a customer's visit to a store until completion of transferring of goods 8 will be explained.

A customer visiting a store takes the container 2 from a basket area. The customer carrying the container 2 subsequently moves in the store and puts goods 8 that the customer desires to purchase one by one in the basket body 201 of the container 2. At this moment, the customer shows the goods 8 picked up to the receiver 21 and then puts the goods 8 in the basket body 201. Thus, the receiver 21 acquires respective goods information on the goods 8.

The customer subsequently puts, at the predetermined location (on the bottom of the recess 72 in the counter desk 7), the container 2 that all the goods 8 that the customer desires to purchase are put in. At this moment, a sensor installed, for example, in the bottom of the recess 72 in the counter desk 7 senses that the container 2 is placed on the predetermined location. The sales system 4 receives a sensed result by the sensor and then starts communication with the container 2, thereby acquiring the goods information from the container 2.

When acquiring the goods information, the sales system 4 transmits (transfers) the goods information to the checkout system 5. The sales system 4 acquires price data transmitted as a reply (response) to the goods information from the checkout system 5. Moreover, the sales system 4 creates a purchase list containing pieces of information on the goods 8 based on the price data thus acquired.

Moreover, at this time, the sales system 4 judges whether or not the purchase list includes specific goods which require age verification. As an example of the specific goods, the present embodiment includes alcohol (alcohol goods). Herein, the sales system 4 judges whether or not alcohol is included in the goods 8 put in the container 2 based on the purchase list. When alcohol is contained in the purchase list, the sales system 4 transmits a start signal to the age verification system 9. The age verification system 9 receives the start signal and then starts a series of steps for the age verification.

When the age verification system 9 succeeds in the age verification, or when the purchase list includes no alcohol, the sales system 4 causes the display device 43 to display an on-screen confirmation for cigarettes. With the on-screen confirmation for cigarettes, it is confirmed whether or not cigarettes which are the specific goods are to be purchased. When “purchasing the cigarettes” is selected in the on-screen confirmation for cigarettes, the sales system 4 transmits the start signal to the age verification system 9. When the age verification system 9 succeeds in the age verification, the sales system 4 causes the display device 43 to display an on-screen cigarette menu that allows customers to select one of cigarette brands. Note that when the purchase list includes alcohol and the age verification has already been successfully performed, the sales system 4 may cause the display device 43 to display the on-screen cigarette menu directly after “purchase cigarettes” is selected on the on-screen confirmation for cigarettes.

In the on-screen cigarette menu, when one or more specific cigarette brands are selected, the sales system 4 transmits the respective one or more pieces of goods information of the one or more specific cigarette brands to the supply unit 42. The supply unit 42 selects corresponding one or more cigarette packs from cigarette packs stocked in the supply unit 42 and dispenses the one or more cigarette packs (i.e., cigarettes) thus selected to an outlet 421 (see FIG. 3). This configuration enables customers to receive the cigarettes dispensed through the outlet 421. Moreover, the sales system 4 acquires price data of the cigarettes from the checkout system 5 and adds the price data to the purchase list.

When supply of the cigarettes from the supply unit 42 is completed or “do not purchase cigarettes” is selected in the on-screen confirmation for cigarettes, the sales system 4 proceeds to the checkout process. At this time, the sales system 4 causes the display device 43 to display an on-screen checkout confirmation including the purchase list. When start checkout is selected in the on-screen checkout confirmation, the sales system 4 causes the checkout system 5 to start the checkout process.

Moreover, when the age verification system 9 fails the age verification, the sales system 4 stops the sales process of the specific goods (in this embodiment, alcohol and cigarettes). When the age verification in a sales process of cigarettes fails, the sales system 4 stops the sales process of the cigarettes and proceeds to the checkout process. When the age verification in a sales process of alcohol fails, the sales system 4 does not display the on-screen confirmation for cigarettes and stops the alcohol sales process.

After the checkout process is started, the sales system 4 causes the storage system 3 to perform transferring. That is, the sales system 4 causes the checkout system 5 to start the checkout process and then transmits, to the storage system 3, a control signal for starting a storing process. Thus, the storage device 31 of the storage system 3 accordingly starts the transferring of the goods 8 from the container 2 to the bag 10 while the checkout process of the goods 8 is being performed. Note that preferably after the checkout process is completed, the customer is allowed to receive the bag 10 storing the goods 8 with the storing process by the storage device 31 being completed.

(3.2) Operation of Storage Device

Next, operation of the storage device 31 will be described with reference to FIGS. 5A to 5C and FIGS. 6A to 6C. In FIGS. 5A to 6C, the operation of the storage device 31 is schematically illustrated, and the bag supply device 32 and the like are accordingly omitted in the drawings. In FIGS. 5A to 5C and FIG. 6A, no goods 8 are stuck at the outlet 203 of the container 2. When the relative positional relationship between the support 311 and the guide section 312 corresponds to the third state, no goods 8 remain in the container 2. That is, in the examples shown in FIGS. 5A to 5C and FIG. 6A, the storage device 31 normally performs the transfer operation.

First, when the relative positional relationship between the support 311 and the guide section 312 corresponds to the first state as illustrated in FIG. 5A, the bag (different container) 10 is put on the support 311 and the guide section 312 with a bag opening 101 of the bag 10 facing downward. The bottom part 102 of the bag 10 is supported by the mount surface 314. The storage device 31 shown in FIG. 5A is in a stand-by state and remains in the stand-by state until the storage device 31 receives a control signal from the management device 41.

When receiving the control signal from the management device 41, the storage device 31 starts the storing process. When the storing process is started, the bottom panel 202 of the container 2 is opened as illustrated in FIG. 5B, so that an item of goods 8 in the container 2 is discharged through the outlet 203 onto the mount surface 314 of the storage device 31. Thus, the item of goods 8 is placed on the bag 10 on the mount surface 314. Here, the bottom panel 202 is held on the mount surface 314 by holding force of a holding mechanism in addition to the weight of the item of goods 8. That is, the transfer operation includes an operation of opening and closing the bottom panel 202 to open and close the outlet 203.

From this state (first state), the elevator unit 313 moves the support 311 downward relative to the guide section 312, thereby changing the relative positional relationship between the support 311 and the guide section 312 to the second state. In the second state, the item of goods 8 is not stuck at the outlet 203 of the container 2, and therefore, the item of goods 8 also moves downward as the support 311 moves. The item of goods 8 remains on the bag 10 on the mount surface 314. The second state is maintained during an execution time period of a first determining process by the recognition system 1 which will be described later.

From the state (second state), the elevator unit 313 further moves the support 311 downward relative to the guide section 312, so that the bag 10 is gradually drawn into an inner side of the guide section 312. At this time, a side peripheral part 103 of the bag 10 which is continuous to the bottom part 102 of the bag 10 is drawn into the inner side of the guide section 312 while the side peripheral part 103 is squeezed by the upper end surface of the guide section 312. Thus, the guide section 312 around the support 311 raises the side peripheral part 103 of the bag 10 from the outer periphery of the bottom part 102.

When the relative positional relationship between the support 311 and the guide section 312 transitions to the third state as illustrated in FIG. 6A, the bag 10 is, in a space surrounded by the guide section 312, turned inside out from the state shown in FIG. 5A, so that the item of goods 8 is stored in the bag 10. At this time, the side peripheral part 103 is in a raised state along an inner peripheral surface of the guide section 312. Here, the storage device 31 is configured such that in the second state, a level difference from the mount surface 314 to the upper end surface of the guide section 312 is larger than or equal to the total length of the bag 10 in the vertical direction. Herein “the total length of the bag 10 in the vertical direction” refers to a total length including a pair of handles 104 of the bag 10, that is, a dimension from the bottom part 102 of the bag 10 to tips of the handles 104. Thus, the bag 10 inclusive of the tips of the handles 104 is fit in a space surrounded by the guide section 312. Thus, the bag 10 inclusive of not only the side peripheral part 103 but also the handles 104 is in the raised state. The state shown in FIG. 6A (that is, the third state, and the bottom panel 202 of the container 2 is open) is maintained during the execution time period in the second determining process which will be described later and which is performed by the recognition system 1.

Next, the storage device 31 closes the bottom panel 202 of the container 2 as illustrated in FIG. 6B. Then, the container 2 is removed from the storage device 31, and thereafter, the storage device 31 drives the support 311 by the elevator unit 313 to change the relative positional relationship between the support 311 and the guide section 312 from the third state to the first state. The bag 10 is thus released from the space surrounded by the guide section 312.

That is, as the support 311 moves upward, the bag 10 on the mount surface 314 goes upward through the opening on a side facing the upper surface of the guide section 312. Moreover, the support 311 moves upward, thereby completely releasing the bag 10 from the space surrounded by the guide section 312 as illustrated in FIG. 6C. At this time, the bag 10 inclusive of the handles 104 maintains an independent position. Moreover, the bag 10 is turned inside out from the state of the bag 10 supplied by the bag supply device 32 in FIG. 6A so as to store the item of goods 8. Therefore, when characters and the like are printed on the bag 10, mirror printing is preferably adopted to the bag 10. Thus, a customer can receive the item of goods 8 transferred in the bag 10.

(3.3) Operation of Recognition System

Next, operation of the recognition system 1 will be described with reference to FIGS. 5A to 14. After the storing process by the storage device 31 is started, the recognition system 1 receives a state signal from the storage device 31, for example, via the management device 41 so as to grasp the relative positional relationship between the support 311 and the guide section 312 and an open/close state of the bottom panel 202 of the container 2.

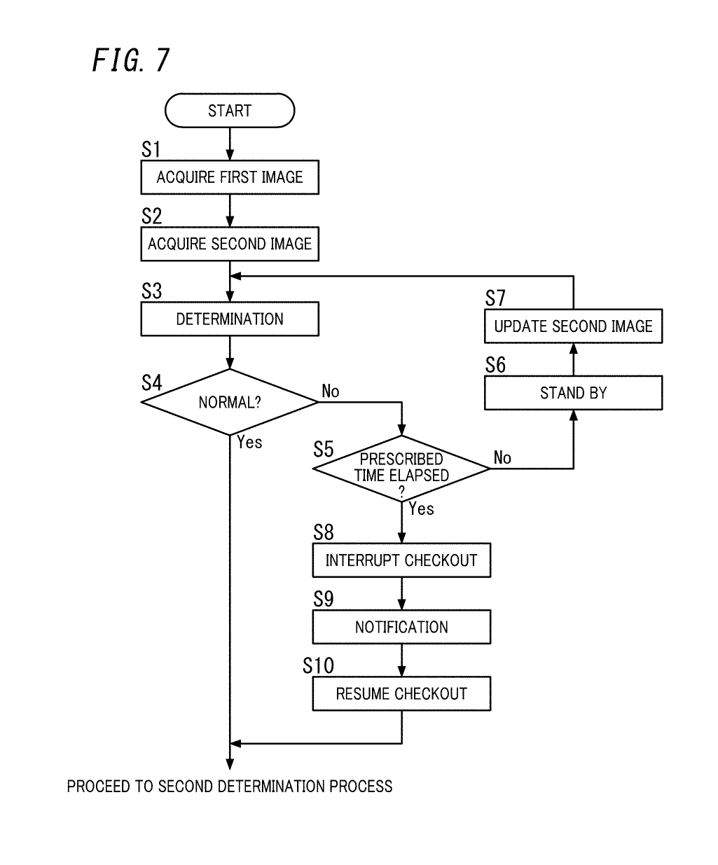

First, the first determining process by the determining processor 12 will be described mainly with reference to FIG. 7. When the relative positional relationship between the support 311 and the guide section 312 corresponds to the first state, and the bottom panel 202 of the container 2 is open (see FIG. 5B), the ranging sensor 111 of the recognition processing unit 11 acquires a distance image (51). The distance image at this time is hereinafter referred to as a “first image A1” (see FIG. 8A and FIG. 8C). Next, when the relative positional relationship between the support 311 and the guide section 312 becomes the second state (see FIG. 5C), the ranging sensor 111 performs acquisition again to acquire a distance image (S2). The distance image at this time is hereinafter referred to as a “second image A2” (see FIGS. 8B and 8D).

The determining processor 12 determines, with reference to the first image A1 and the second image A2, whether or not the item of goods 8 is stuck at the outlet 203 of the container 2 so as to determine whether or not the transfer operation is normal (S3). In other words, the determining processor 12 determines, based on a change of the state in the container 2 caused due to the transfer operation, whether or not the transfer operation is normal. Herein “the change of the state in the container” refers to a change of the state in the container 2 represented by the first image A1 to the state in the container 2 represented by the second image A2. In particular, in the present embodiment, the determining processor 12 is configured to determine whether or not the transfer operation is normal based on a difference between a state in the container 2 prior to a start time point of an operation of the movement mechanism (see FIG. 5B) and a state in the container 2 after the start time point (see FIG. 5C). Moreover, in the present embodiment, the state in the container 2 after the start time point is a state in the container 2 prior to an end time point of the operation of the movement mechanism.

In the present embodiment, the determining processor 12 calculates the difference between the distance information of the first image A1 and the distance information of the second image A2 (in this embodiment, difference in shade), and if the difference exceeds the prescribed range, the determining processor 12 determines that the transfer operation is normal (S4: Yes). In contrast, if the difference is within the prescribed range, the determining processor 12 determines that the transfer operation is abnormal (S4: No). For example, the determining processor 12 calculates difference between distance information of each pixel of the first image A1 and distance information of a corresponding pixel of the second image A2, and if the number of pixels with a difference in distance information more than the prescribed range is more than or equal to a certain number, the determining processor 12 determines that the transfer operation is normal. In contrast, if the number of pixels with a difference in distance information more than the prescribed range is less than the certain number, the determining processor 12 determines that the transfer operation is abnormal.

That is, when the item of goods 8 is not stuck at the outlet 203, the item of goods 8 moves downward together with the support 311 along with a change of the relative positional relationship between the support 311 and the guide section 312 from the first state to the second state (see FIG. 5C). Thus, in this case, as illustrated in FIGS. 8A and 8B, the area B1 corresponding to the bottle (item of goods 8) in the second image A2 overall has a darker color than the area B1 corresponding to the bottle in the first image A1. In this case, the number of pixels with a difference in distance information between the first and second images A1 and A2 more than the prescribed range is more than or equal to the certain number. Thus, the determining processor 12 determines that the transfer operation is normal.

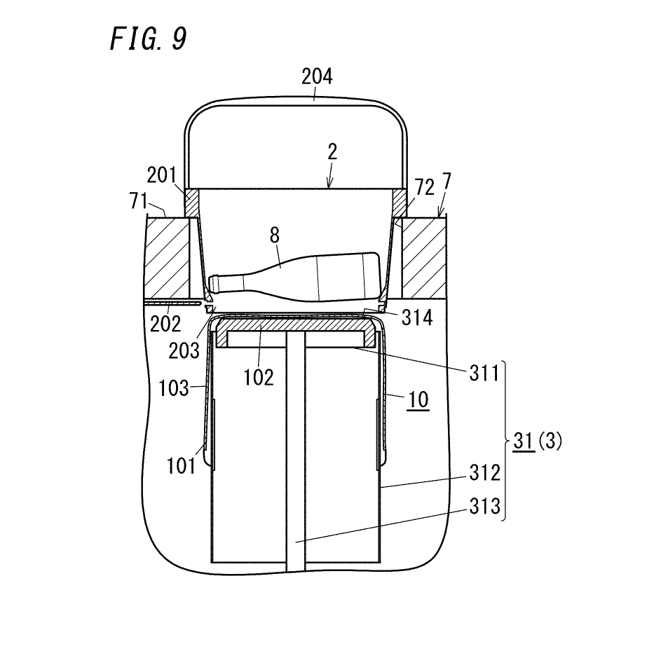

In contrast, when the item of goods 8 is stuck at the outlet 203 as illustrated in FIG. 9, the item of goods 8 does not move together with the support 311 along with a change of the relative positional relationship between the support 311 and the guide section 312 from the first state to the second state. Thus, in this case, as illustrated in FIGS. 8C and 8D, the color in the area B1 corresponding to the bottle (the item of goods 8) in the second image A2 does not substantially change from the color of the area B1 corresponding to the bottle in the first image A1. In this case, the difference between the distance information of the first image A1 and the distance information of the second image A2 is within the prescribed range. Thus, the determining processor 12 determines that the transfer operation is abnormal.

When it is determined that the transfer operation is abnormal (S4: No), and a predetermined time (e.g., several seconds) has not elapsed since the start time point of the first determining process (S5: No), the determining processor 12 stands by for a constant time (e.g., several hundred milliseconds) (S6). When the constant time has elapsed, the ranging sensor 111 of the recognition processing unit 11 performs acquisition again to acquire a distance image (S7). At this time, the relative positional relationship between the support 311 and the guide section 312 remains in the second state. Thus, the distance image acquired by the ranging sensor 111 corresponds to the second image A2. That is, the ranging sensor 111 performs the acquisition again to acquire a distance image, thereby updating the second image A2. The determining processor 12 determines again whether or not the transfer operation is normal based on the first image A1 and the second image A2 which is updated (S3). The above-described process is repeated until a predetermined time has elapsed since the start time point of the first determining process or until the item of goods 8 is released from the outlet 203 before the predetermined time elapses.

When the item of goods 8 is not stuck at the outlet 203, or when the item of goods 8 is released from the outlet 203 before a predetermined time has elapsed since the start time point of the first determining process, the determining processor 12 outputs a signal via the management device 41 to the storage device 31. The signal denotes that the transfer operation is normal. Thus, the storage device 31 changes the relative positional relationship between the support 311 and the guide section 312 from the second state to the third state (see FIG. 6A). That is, the storage device 31 is configured to perform the transfer operation based on the determination result by the determining processor 12. The determining processor 12 then starts the second determining process.

On the other hand, when it is determined that the transfer operation is still abnormal (S4: No), and the predetermined time has elapsed since the start time point of the first determining process (S5: Yes), the determining processor 12 interrupts the checkout process by the checkout system 5 via the management device 41 (S8). The communication unit 13 then outputs a notification signal to the management device 41 (S9).

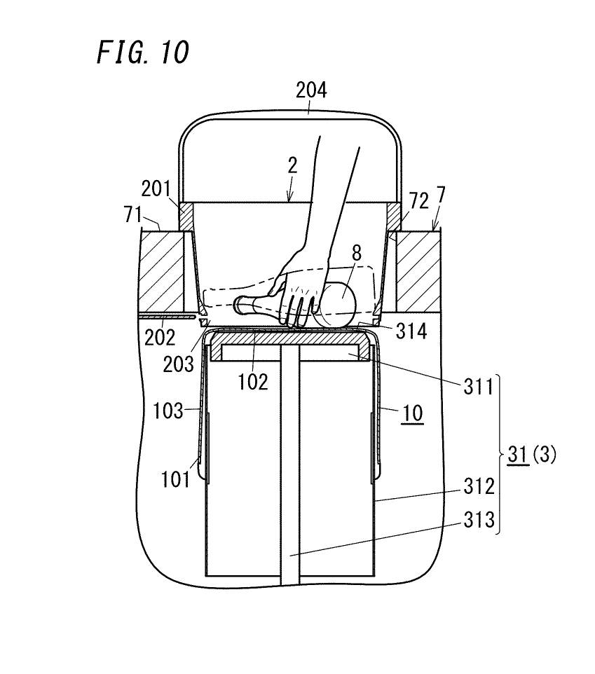

The management device 41 which receives the notification signal causes the display device 43 or the voice output device 45 to display or to reproduce, for example, a message such as “Goods are stuck at the outlet of the container. Please remove the goods from the outlet” for prompting correction. A customer who sees (or hears) this message may attempt to perform the correction by, for example, taking the item of goods 8 out of the outlet 203 and placing it on the mount surface 314 as shown in FIG. 10.

When the constant time has elapsed since the output of the notification signal, or when the input device 44 receives a manipulation representing that the correction is completed, the determining processor 12 causes the checkout system 5 to resume the checkout process via the management device 41 (S10). The determining processor 12 then outputs a signal denoting that the transfer operation is normal to the storage device 31 via the management device 41, thereby starting the second determining process.

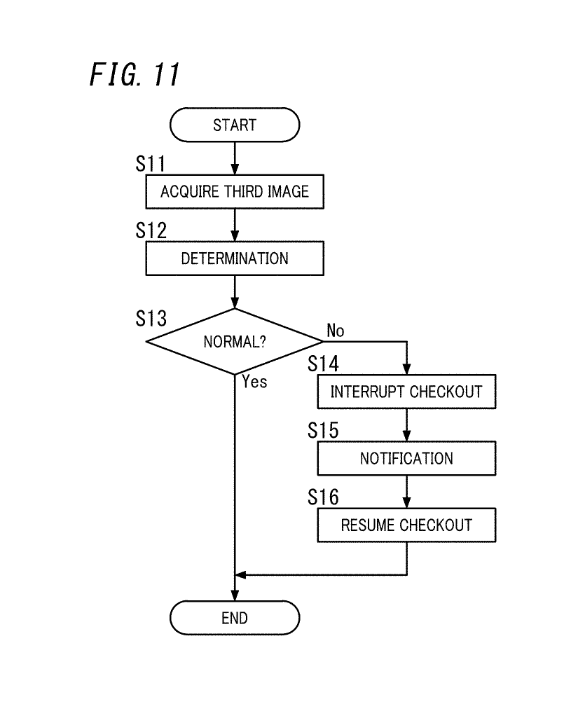

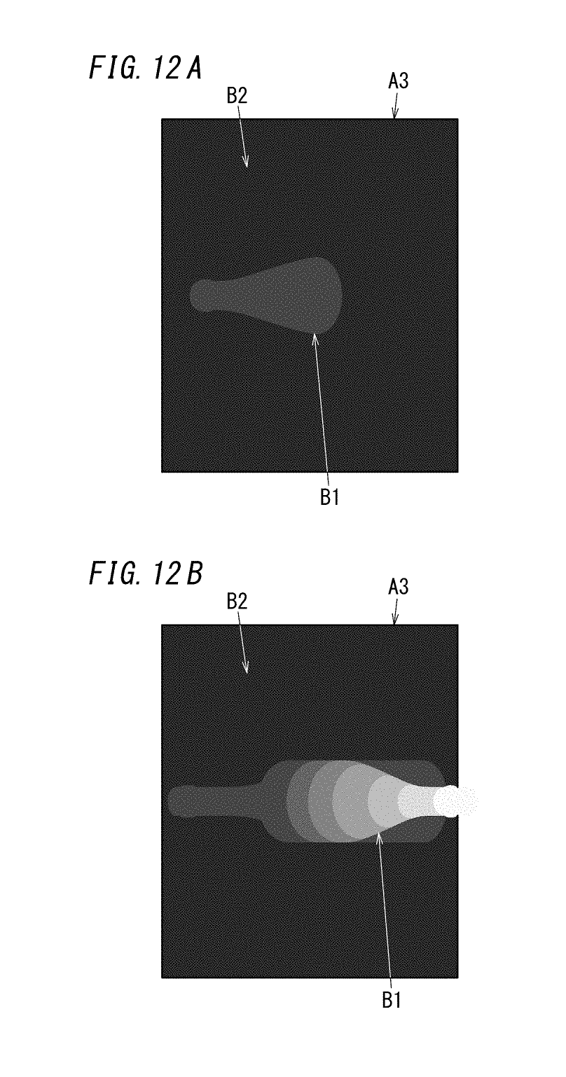

Next, the second determining process by the determining processor 12 will be described with reference to mainly FIG. 11. When the relative positional relationship between the support 311 and the guide section 312 transitions to the third state (see FIG. 6A), the ranging sensor 111 of the recognition processing unit 11 acquires a distance image (S11). A distance image at this time is hereinafter referred to as a “third image A3” (see FIGS. 12A and 12B).

The determining processor 12 determines whether or not one or more goods 8 remain in the container 2 based on the third image A3, thereby determining whether or not the transfer operation is normal (S12). In other words, the determining processor 12 determines whether or not the transfer operation is normal based on a state in the container 2 at the end time point of the operation of the movement mechanism (see FIG. 6A). In the present embodiment, if the third image A3 does not include a pixel showing that corresponding distance information (shade) is shorter (lighter) than a prescribed distance (a prescribed shade) (the distance from the ranging sensor 111 to the outlet 203), the determining processor 12 determines that the transfer operation is normal (S13: Yes). In contrast, if the third image A3 includes a pixel showing that corresponding distance information is shorter than the prescribed distance, the determining processor 12 determines that the transfer operation is abnormal (S13: No).

That is, when no goods 8 remain in the container 2, as illustrated in FIG. 12A, the area B1 corresponding to bottles (the goods 8) in the third image A3 has a darker color than when an object is present in the above prescribed distance. In this case, the third image A3 does not include a pixel showing that corresponding distance information is shorter than the prescribed distance. Thus, the determining processor 12 determines that the transfer operation is normal.

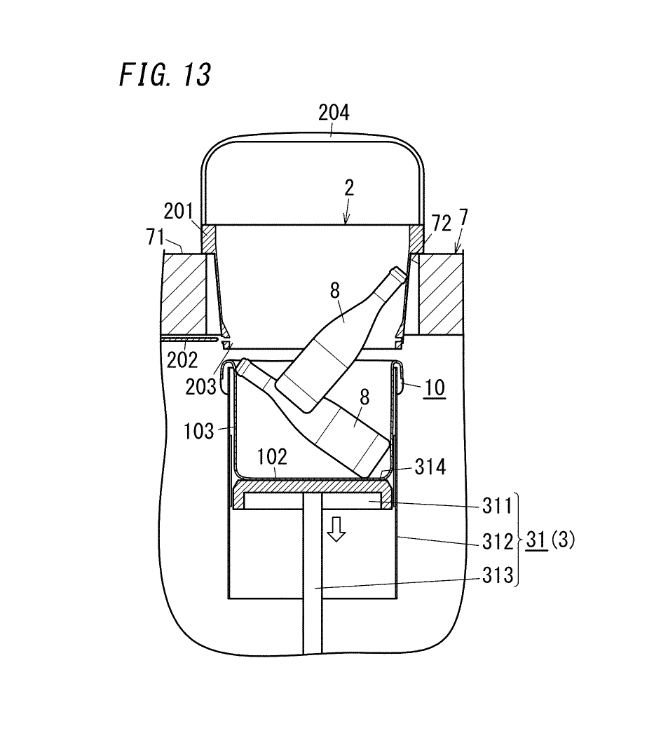

In contrast, when, for example, the goods 8 are stacked on each other, and some of the goods 8 remain in the container 2 as illustrated in FIG. 13, part of the area B1 has a lighter color as illustrated in FIG. 12B than when an object is present in the prescribed distance. In this case, the third image A3 includes a pixel showing that corresponding distance information is shorter than the prescribed distance. Thus, the determining processor 12 determines that the transfer operation is abnormal.

When it is determined that the transfer operation is abnormal (S13: No), the determining processor 12 interrupts the checkout process by the checkout system 5 via the management device 41 (S14). The communication unit 13 outputs the notification signal to the management device 41 (S15).

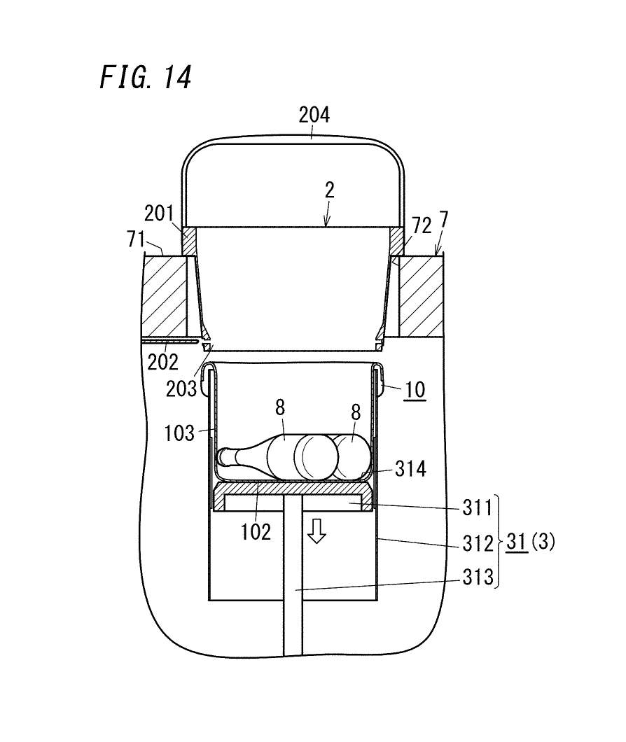

The management device 41 which receives the notification signal causes the display device 43 or the voice output device 45 to display or to reproduce, for example, a message such as “Goods remain in the container. Please move the goods so that the goods do not remain in the container” for prompting correction. A customer who sees (or hears) this message may attempt to perform the correction by, for example, moving the goods 8 so that no goods 8 remain in the container 2 as shown in FIG. 14.

When the constant time has elapsed since the output of the notification signal, or when the input device 44 receives a manipulation representing that the correction is completed, the determining processor 12 causes the checkout system 5 to resume the checkout process via the management device 41 (S16). The determining processor 12 then outputs a signal denoting that the transfer operation is normal to the storage device 31 via the management device 41, thereby terminating the determining process. Then, the storage device 31 changes the relative positional relationship between the support 311 and the guide section 312 from the third state to the first state and completes the storing process (see FIGS. 6A to 6C).

(4) Variation

The above-described embodiment is a mere example of various embodiments of the present disclosure. Various modifications are possible depending on design and the like as long as the object of the present disclosure can be achieved. Moreover, functions similar to those of the storage system 3 may be realized by a storage control method, a computer program, a non-transitory storage medium storing a computer program, or the like.

A storage control method according to one aspect includes recognizing a state in a container 2 which allows one or more goods 8 to be put in. The storage control method further includes determining, based on a recognition result in a transfer operation, whether or not the transfer operation is normal. The transfer operation is an operation of transferring each of the one or more goods 8 from the container 2 into a bag (different container) 10 by a movement mechanism (a support 311, a guide section 312, and an elevator unit 313) configured to move each of the one or more goods 8. The storage control method further includes controlling the movement mechanism based on a determination result.

A program according to one aspect is a program that causes a computer system to execute a recognition process, a determining process, and a storage control process. The recognition process is a process of recognizing a state in a container 2 which allows one or more goods 8 to be put in. The determining process is a process of determining, based on a recognition result in a transfer operation, whether or not the transfer operation is normal. The transfer operation is an operation of transferring each of the one or more goods 8 from the container 2 into a bag (different container) 10 by a movement mechanism (a support 311, a guide section 312, and an elevator unit 313) configured to move each of the one or more goods 8. The storage control process is a process of controlling the movement mechanism based on a determination result in the determining process.

Variations of the above-described embodiment will be described below. The variations described below may be combined as appropriate.

In the shopping assistance system 100 in the present disclosure, the recognition system 1, the storage system 3, the sales system 4, and the like include respective computer systems. Each computer system includes a processor as hardware and a memory as main components. The processor executes a program stored in the memory of each computer system, thereby realizing the function as the shopping assistance system 100 of the present disclosure. The program may be stored in the memory of each computer system in advance, provided via telecommunications network, or provided via a non-transitory computer-readable storage medium such as a memory card, an optical disk, a hard disk drive, or the like storing the program. The processor of each computer system includes one or more electronic circuits including a semiconductor integrated circuit (IC) or a large-scale integrated circuit (LSI). The integrated circuit such as IC or LSI mentioned herein may be referred to in another way, depending on the degree of the integration and includes integrated circuits called system LSI, very-large-scale integration (VLSI), or ultra-large-scale integration (VLSI). A field-programmable gate array (FPGA), which is programmable after fabrication of the LSI, or a logical device which allows reconfiguration of connections in LSI or reconfiguration of circuit cells in LSI may be adopted as the processor. The plurality of electronic circuits may be integrated into a single chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

Collecting the plurality of functions in the shopping assistance system 100 in one housing is not an essential configuration for the shopping assistance system 100. The components of the shopping assistance system 100 may be distributed in a plurality of housings. Moreover, at least some functions of the shopping assistance system 100 may be realized by, for example, cloud (cloud computing) or the like. In contrast, in the above-described embodiment, at least some of functions of the shopping assistance system 100 distributed in a plurality of device may be collected in one housing.

In the above-described embodiment, the ranging sensor 111 may be disposed directly above the container 2 placed at the predetermined location. In this case, the ranging sensor 111 measures the distance to the object in the container 2 from directly above the container 2. Thus, image processing such as trapezoid correction is not required.

In the above-described embodiment, the recognition processing unit 11 may include a configuration for recognizing the state in the container 2 other than the ranging sensor 111. For example, the recognition processing unit 11 may include an image sensor, transmission-type optical sensor (photo interrupter), a reflection-type optical sensor, or the like alternatively to the ranging sensor 111 or in addition to the ranging sensor 111. The recognition processing unit 11 may include a transmission-type (or reflection-type) ultrasonic sensor alternatively to the ranging sensor 111 or in addition to the ranging sensor 111.

In the above-described embodiment, the determining processor 12 determines, in the second determining process, whether or not the transfer operation is normal based on the state in the container 2 at an end time point of the operation of the movement mechanism, but the determining processor 12 is not limited to this example. For example, the determining processor 12 may determine, in the second determining process, whether or not the transfer operation is normal based on whether or not each of the goods 8 passes through the outlet 203 of the container 2 during the transfer operation. In this case, the recognition processing unit 11 is preferably configured to sense whether or not each of the goods 8 passes through the outlet 203 by the optical sensor or the ultrasonic sensor. For example, when one or more goods 8 remain in the container 2 with the relative positional relationship between the support 311 and the guide section 312 corresponding to the third state, the optical sensor or the ultrasonic sensor senses that each of the goods 8 passes through the outlet 203. In this case, the determining processor 12 determines that the transfer operation is abnormal. In contrast, when no goods 8 remain in the container 2, the optical sensor or the ultrasonic sensor senses that each of the one or more goods 8 do not pass through the outlet 203. In this case, the determining processor 12 determines that the transfer operation is normal.

In the above-described embodiment, during the execution time period of the first determining process, the support 311 is stopped, and the relative positional relationship between the support 311 and the guide section 312 is maintained in the second state, but the first determining process is not limited to this example. For example, the first determining process may be performed while the support 311 is being moved downward. In this case, it is only required that the support 311 is stopped at the time point at which the first determining process determines that the transfer operation is abnormal.

In the above-described embodiment, when the determining processor 12 interrupts the checkout process by the checkout system 5 in the first determining process (S8 in FIG. 7), the determining processor 12 causes the checkout process to be resumed without performing the first determining process again (S10 in FIG. 7), but the determining processor 12 is not limited to this example. For example, in the above-described case, the determining processor 12 may restart the process from updating of the second image A2 (S7 in FIG. 7) with an assumption that the input device 44 receives a manipulation representing completion of correction in a state where a customer forgets to remove the one or more goods 8 from the outlet 203. This aspect provides the advantage that even when a customer forgets to remove the one or more goods 8 from the outlet 203, it is possible to determine at an early stage that the transfer operation still involves an abnormality. Note that in this aspect, if the determination performed again determines that the transfer operation is normal, the determining processor 12 causes the checkout system 5 to resume the checkout process, and then starts the second determining process.

In the above-described embodiment, when the determining processor 12 interrupts the checkout process by the checkout system 5 in the second determining process (S14 in FIG. 11), the determining processor 12 causes the checkout process to be resumed without performing the second determining process again (S16 in FIG. 11), but the determining processor 12 is not limited to this example. For example, in the determining processor 12 described above may restart the process from acquiring of the third image A3 (S11 in FIG. 11) with an assumption that the input device 44 receives a manipulation representing completion of correction in a state where a customer forgets to move the one or more goods 8 from the container 2. This aspect provides the advantage that even when a customer forgets to move the one or more goods 8 from the container 2, it is possible to determine at an early stage that the transfer operation still involves an abnormality. Note that in this aspect, if the determination performed again determines that the transfer operation is normal, the determining processor 12 causes the checkout system 5 to resume the checkout process.

In the above-described embodiment, the determining processor 12 performs both the first determining process and the second determining process as the determining processes, but the determining processor 12 is not limited to this example. For example, the determining processor 12 may be configured to perform only one of the first determining process and the second determining process as the determining process. That is, it is only required that the determining processor 12 is configured to determine at least one of whether or not the one or more goods 8 are stuck at the outlet 203 of the container 2 or whether or not the one or more goods 8 remain in the container 2 when the relative positional relationship between the support 311 and the guide section 312 corresponds to the third state.

In the above-described embodiment, the container 2 does not have to include the receiver 21. For example, instead of providing the container 2 with the receiver 21, the storage device 31 may include an information acquiring device for acquiring respective goods information on one or more goods 8. The information acquiring device is configured to read respective goods information from radio frequency (RF) tags added to the one or more goods 8 so as to acquire the respective goods information. In this case, the information acquiring device reads the respective goods information when the storage device 31 transfers the one or more goods 8. That is, the information acquiring device reads the respective goods information during a read time period after the start of the storing process until the bag (different container) 10 storing the one or more goods 8 is released from the storage device 31. Moreover, in this case, the information acquiring device transmits the respective goods information to the sales system 4.

In the above-described embodiment, the outlet 203 is a bottom surface of the basket body 201 of the container 2, but the outlet 203 is not limited to this example. For example, the outlet 203 may be provided to a side part of the basket body 201 of the container 2. In this case, the storage device 31 is disposed, for example, next to the recess 72 in the counter desk 7, and an appropriate movement mechanism (e.g., belt conveyor) transfers one or more goods 8 from the container 2 through the outlet 203 into the different container 10. In this case, the determining processor 12 determines whether or not one or more goods 8 remain in the container 2 with reference to the recognition result by the recognition processing unit 11, which enables the determining processor 12 to determine whether or not the transfer operation is normal. The outlet 203 may be an upper opening in the basket body 201 of the container 2.

In the above-described embodiment, when the determining processor 12 determines that the transfer operation is abnormal, the communication unit 13 outputs the notification signal to the sales system 4, but the communication unit 13 is not limited to this example. For example, the communication unit 13 may be configured to output a notification signal to the portable terminal 6 carried by a clerk when the determining processor 12 determines that the transfer operation is abnormal. In this case, when the clerk checks the portable terminal 6 which receives the notification signal, it becomes possible to notify a customer that the abnormality occurs in the transfer operation, or to take appropriate measures, for example, a clerk goes to the counter desk 7 to perform correction instead of the customer.

In the above-described embodiment, the recognition system 1, instead of a customer, may mechanically perform the correction. For example, the recognition system 1 has a mechanism for vibrating the container 2, and the vibration may be given to the container 2 by the mechanism so as to attempt to release each of the one or more goods 8 from the outlet 203 of the container 2 or to move each of the one or more goods 8 remaining the container 2 downward.

In the above-described embodiment, the container 2 is not limited to the shopping basket but may be a shopping cart or the like.

In the above-described embodiment, the one or more goods 8 are bottles, but goods 8 are not limited to this example. For example, the goods 8 are not limited to including food and drinks such as PET-bottled beverage, canned beverage, paper-packed beverage, boxed confectionery, and bagged confectionery but may include articles of daily use such as ball-point pens and other products.

### SUMMARY

As described above, a recognition system (1) according to a first aspect includes a recognition processing unit (11) and a determining processor (12). The recognition processing unit (11) is configured to recognize a state in a container (2) which allows one or more goods (8) to be put in. The determining processor (12) is configured to determine, based on a recognition result by the recognition processing unit (11) in a transfer operation, whether or not the transfer operation is normal. The transfer operation is an operation of transferring each of the one or more goods (8) from the container (2) into a different container (10) by a movement mechanism (a support (311), a guide section (312), and an elevator unit (313)) configured to move each of the one or more goods (8).

With this aspect, it is possible to determine whether or not each of the one or more goods (8) is normally transferred from the container (2) into the different container (10) smoothly, and whether or not an abnormality occurs in the process of transferring each of the one or more goods (8) from the container (2) into the different container (10). If the abnormality in the transfer operation is left as it is, a problem, for example, that the container (2) is removed with at least an item of goods (8) remaining in the container (2) may occur. In this case, a clerk has to solve the problem, and such a case is inconvenient for the clerk. In contrast, with this aspect, based on the determination result, if the abnormality is included in, for example, the transfer operation, a customer, a clerk, or the like is allowed to perform correction so that the transfer operation is normally performed. Thus, this aspect provides the advantage that a problem is suppressed in a job of transferring each of the one or more goods (8) from the container (2) into the different container (10) by a machine (here, the movement mechanism) than in a case where normality/abnormality of the transfer operation is not determined.

In a recognition system (1) according to a second aspect referring to the first aspect, the container (2) has an opening (outlet) (203) which is openable and closable. The transfer operation is an operation of changing a positional relationship of each of the one or more goods (8) relative to the container (2) in a state where the opening (203) in the container (2) is open, to transfer each of the one or more goods (8) from the container (2) through the opening (203) into the different container (10).

This aspect provides the advantage that the determining processor (12) can determine an abnormality such as sticking of the one or more goods (8) at the opening (203) in the transfer operation.

In a recognition system (1) according to a third aspect referring to the first or second aspect, the transfer operation is an operation of lowering each of the one or more goods (8) relative to the container (2) in a state where an opening (outlet) (203) in the container (2) is open, to change a positional relationship of each of the one or more goods (8) relative to the container (2) to transfer each of the one or more goods (8) from the container (2) through the opening (203) into the different container (10).

In a recognition system (1) according to a fourth aspect referring to any one of the first to third aspects, the determining processor (12) determines, based on a change of the state in the container (2) caused due to the transfer operation, whether or not the transfer operation is normal.

In this aspect, whether or not the transfer operation is normal is more easily determined than in a case where determination is performed based on only the state in the container (2) at any time point in the transfer operation.

In a recognition system (1) according to a fifth aspect referring to the fourth aspect, the determining processor (12) is configured to determine whether or not the transfer operation is normal based on a difference between a state in the container (2) prior to a start time point of an operation of the movement mechanism and a state in the container (2) after the start time point.

According to this aspect, it is possible to determine whether or not the transfer operation is normal at an earlier stage than in a case where determination is performed based on the difference between two states in the container (2) during operation of the movement mechanism.

In a recognition system (1) according to a sixth aspect referring to the fifth aspect, the state in the container (2) after the start time point is a state in the container (2) prior to an end time point of the operation of the movement mechanism.

According to this aspect, it is possible to easily determine whether or not the transfer operation is normal before the transfer operation ends.

In a recognition system (1) according to a seventh aspect referring to any one of the first to third aspects, the determining processor (12) determines whether or not the transfer operation is normal based on a state in the container (2) at an end time point of the operation of the movement mechanism.

According to this aspect, if in a job of transferring each of the one or more goods (8) from the container (2) into a different container (10), a next operation following the transfer operation is to be performed, it is possible to easily determine, based on a determination result by the determining processor (12), whether or not the next operation may be started.

In a recognition system (1) according to an eighth aspect referring to any one of the first to third aspects, the container (2) has an opening (outlet) (203) which is openable and closable. The determining processor (12) is configured to determine whether or not the transfer operation is normal based on whether or not each of the one or more goods (8) passes through the opening (203) in the container (2) during the transfer operation.

This aspect provides the advantage that an abnormality, such as remaining of at least an item of goods (8) in the container (2), in the transfer operation can be determined by the determining processor (12).

In a recognition system (1) according to a ninth aspect referring to any one of the first to eighth aspects, the recognition processing unit (11) includes a ranging sensor (111). The ranging sensor (111) is disposed outside the container (2) and is configured to measure a distance to an object in the container (2). The recognition processing unit (11) is configured to recognize the state in the container (2) based on the distance.

According to this aspect, a change of the state in the container (2) is easily recognized.

In a recognition system (1) according to a tenth aspect referring to the ninth aspect, the ranging sensor (111) is disposed at a location which is higher than the container (2) in a gravity direction and which is deviated from a center of the container (2) in a horizontal surface.

In this aspect, the distance to the object in the container (2) is more easily measured than in a case where the ranging sensor (111) is disposed at the center of the container (2) in the horizontal surface (i.e., directly above the container (2)). That is, for example, if, when the container (2) is a shopping basket having grips (204), the ranging sensor (111) is disposed directly above the container (2), the grips (204) may hinder the measurement. In contrast, if the ranging sensor (111) is disposed at a location deviated from the center of the container (2) in the horizontal surface, the ranging sensor (111) easily measures the distance to the object in the container (2) while avoiding the grips (204).

A recognition system (1) according to an eleventh aspect referring to any one of the first to tenth aspects further includes a communication unit (13). The communication unit (13) is configured to output a notification signal when the determining processor (12) determines that the transfer operation is abnormal.

With this aspect, outputting the notification signal easily prompts, for example, a customer or a clerk to take measures to correct the abnormality in the transfer operation.

A storage system (3) according to the twelfth aspect includes a recognition system (1) according to any one of the first to eleventh aspects and a storage device (31). The storage device (31) is configured to perform the transfer operation.

This aspect provides the advantage that a problem is suppressed in a job of transferring each of the one or more goods (8) from the container (2) into the different container (10) by a machine (a support (311), a guide section (312), and an elevator unit (313)).

In a storage system (3) according to a thirteenth aspect referring to the twelfth aspect, the storage device (31) is configured to perform the transfer operation based on a determination result by the determining processor (12).

This aspect provides the advantage that transfer operation according to situations can be easily performed. For example, when an abnormality occurs in the transfer operation, the transfer operation may be stopped, or when the abnormality is eliminated, the transfer operation may be resumed.

In a storage system (3) according to a fourteenth aspect referring to the twelfth or thirteenth aspect, the transfer operation includes an operation of opening and closing an opening (outlet) (203) which is formed in a container (2) and which is openable and closable.

This aspect provides the advantage that an abnormality, such as sticking of the goods (8) at the opening (203), in the transfer operation can be determined by the determining processor (12).

A shopping assistance system (100) according to a fifteenth aspect includes the storage system (3) according to any one of the twelfth to fourteenth aspects, and a sales system (4) configured to perform a sales process of the one or more goods (8) put in the container (2).

This aspect provides the advantage that a problem is suppressed in a job of transferring each of the one or more goods (8) from the container (2) into the different container (10) by a machine (a support (311), a guide section (312), and an elevator unit (313)).

A storage control method according to a sixteenth aspect includes recognizing a state in a container (2) which allows one or more goods (8) to be put in. The storage control method further includes determining, based on a recognition result in the transfer operation, whether or not the transfer operation is normal. The transfer operation is an operation of transferring each of the one or more goods (8) from the container (2) into a different container (10) by a movement mechanism (a support (311), a guide section (312), and an elevator unit (313)) configured to move each of the one or more goods (8). The storage control method further includes controlling the movement mechanism based on a determination result.

This aspect provides the advantage that a problem is suppressed in a job of transferring each of the one or more goods (8) from the container (2) into the different container (10) by a machine (a support (311), a guide section (312), and an elevator unit (313)).

A program according to a seventeenth aspect is a program that causes a computer system to execute a recognition process, a determining process, and a storage control process. The recognition process is a process of recognizing a state in a container (2) which allows one or more goods (8) to be put in. The determining process is a process of determining whether or not the transfer operation is normal based on a recognition result in the transfer operation. The transfer operation is an operation of transferring each of the one or more goods (8) from the container (2) into a different container (10) by a movement mechanism (a support (311), a guide section (312), and an elevator unit (313)) configured to move each of the one or more goods (8). The storage control process is a process of controlling the movement mechanism based on a determination result in the determining process.

This aspect provides the advantage that a problem is suppressed in a job of transferring each of the one or more goods (8) from the container (2) into the different container (10) by a machine (a support (311), a guide section (312), and an elevator unit (313)).

The configurations according to the second to eleventh aspects are not configurations essential for the recognition system (1) and may be accordingly omitted. Moreover, the configurations according to the thirteenth and fourteenth aspects are not configurations essential for the storage system (3) and may be accordingly omitted.

1. A recognition system comprising:
a recognition processing unit configured to recognize a state in a container which allows one or more goods to be put in; and
a determining processor configured to determine, based on a recognition result by the recognition processing unit in a transfer operation, whether or not the transfer operation is normal, the transfer operation being an operation of transferring each of the one or more goods from the container into a different container by a movement mechanism configured to move each of the one or more goods.

2. The recognition system according to claim 1, wherein
the container has an opening which is openable and closable, and
the transfer operation is an operation of changing a positional relationship of each of the one or more goods relative to the container in a state where the opening in the container is open, to transfer each of the one or more goods from the container through the opening into the different container.

3. The recognition system according to claim 1, wherein
the transfer operation is an operation of lowering each of the one or more goods relative to the container in a state where an opening in the container is open, to change a positional relationship of each of the one or more goods relative to the container to transfer each of the one or more goods from the container through the opening into the different container.

4. The recognition system according to claim 1, wherein
the determining processor determines, based on a change of the state in the container caused due to the transfer operation, whether or not the transfer operation is normal.

5. The recognition system according to claim 4, wherein
the determining processor is configured to determine whether or not the transfer operation is normal based on a difference between a state in the container prior to a start time point of an operation of the movement mechanism and a state in the container after the start time point.

6. The recognition system according to claim 5, wherein
the state in the container after the start time point is a state in the container prior to an end time point of the operation of the movement mechanism.

7. The recognition system according to claim 1, wherein
the determining processor determines whether or not the transfer operation is normal based on a state in the container at an end time point of the operation of the movement mechanism.

8. The recognition system according to claim 1, wherein
the container has an opening which is openable and closable, and
the determining processor is configured to determine whether or not the transfer operation is normal based on whether or not each of the one or more goods passes through the opening in the container during the transfer operation.

9. The recognition system according to claim 1, wherein
the recognition processing unit includes a ranging sensor disposed outside the container and configured to measure a distance to an object in the container, and the recognition processing unit is configured to recognize the state in the container based on the distance.

10. The recognition system according to claim 9, wherein
the ranging sensor is disposed at a location which is higher than the container in a gravity direction and which is deviated from a center of the container in a horizontal surface.

11. The recognition system according to claim 1 further comprising:
a communication unit configured to output a notification signal when the determining processor determines that the transfer operation is abnormal.

12. The recognition system according to claim 2, wherein
the transfer operation is an operation of lowering each of the one or more goods relative to the container in a state where an opening in the container is open, to change a positional relationship of each of the one or more goods relative to the container to transfer each of the one or more goods from the container through the opening into the different container.

13. The recognition system according to claim 2, wherein
the determining processor determines, based on a change of the state in the container caused due to the transfer operation, whether or not the transfer operation is normal.

14. The recognition system according to claim 3, wherein
the determining processor determines, based on a change of the state in the container caused due to the transfer operation, whether or not the transfer operation is normal.

15. A storage system, comprising:
the recognition system according to claim 1; and
a storage device configured to perform the transfer operation.

16. The storage system according to claim 15, wherein
the storage device is configured to perform the transfer operation based on a determination result by the determining processor.

17. The storage system according to claim 15, wherein
the transfer operation includes an operation of opening and closing an opening which is formed in a container and which is openable and closable.

18. A shopping assistance system, comprising:
the storage system according to claim 15; and
a sales system configured to perform a sales process of the one or more goods put in the container.

19. A storage control method, comprising:
recognizing a state in a container which allows one or more goods to be put in;
determining, based on a recognition result in a transfer operation, whether or not the transfer operation is normal, the transfer operation being an operation of transferring each of the one or more goods from the container into a different container by a movement mechanism configured to move each of the one or more goods; and
controlling the movement mechanism based on a determination result.

20. A non-transitory storage medium recording a program for causing a computer system to execute
a recognition process of recognizing a state in a container which allows one or more goods to be put in,
a determination process of determining, based on a recognition result in a transfer operation, whether or not the transfer operation is normal, the transfer operation being an operation of transferring each of the one or more goods from the container into a different container by a movement mechanism configured to move each of the one or more goods, and
a storage control process of controlling the movement mechanism based on a determination result by the determining process.
